(19) United States
(12) Patent Application Publication
(10) Pub. No.: US 2002/0081112 A1
(43) Pub. Date: Jun. 27, 2002

(54) Printer for use in a Photography Image Processing System

(75) Inventors: Daikichi Morohashi, Hachioji-shi (JP); Gakuzi Kamishima, Hino-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/085,600

(22) Filed: Feb. 27, 2002

Related U.S. Application Data
(62) Division of application No. 09/482,963, filed on Jan. 13, 2000.

(30) Foreign Application Priority Data
Jan. 18, 1999 (JP) 11-009473

(51) Int. Cl. G03B 17/24

(52) U.S. Cl. 396/312

(57) ABSTRACT

A storage section stores voice data obtained by a digital conversion section and a voice compression section by processing a voice input from the voice input section to be imaged as a voice code image. A relating data generating section generates relating data for associating a photography still image recorded on a same printing medium and a voice code image, and stores the generated relating data to be associated with the associated voice data on the storage section. An output section outputs the voice data and relating data stored by the storage section to an external system for recording a still image and a voice code image on the printing medium.

### BACKGROUND OF THE INVENTION

This invention relates to a photography device, such as a film-type camera, an electronic still camera, etc., for use in a photography image processing system capable of recording an optically readable voice code image on a printing medium on which a photographed still image is to be recorded, and a printer.

Various types of photography image processing systems are known which can record an optically readable voice code image, such as a one- or two-dimensional bar code, on a printing medium on which a photographed still image is to be recorded.

For example, such systems are disclosed in Japanese Patent Application KOKAI Publications Nos. 60-244146, 224320 (corresponding to U.S. Pat. No. 5,276,472), 6-231466 (corresponding to U.S. Pat. No. 5,896,403), 7-64215 (corresponding to U.S. Pat. No. 5,363,157), 7-120832, 7-181606 (corresponding to U.S. Pat. No. 5,644,557), etc.

In the photography image processing systems disclosed in the above publications, an optically readable voice code image is recorded on a printing medium. In other words, a photographed still image and a voice can be recorded together on a printing medium such as a paper sheet. Accordingly, the user can easily and instantly hear a voice while seeing a picture, using, for example, a dedicated reader for reading voice code images.

Thus, the user can enjoy images and voices in a different manner from the manner in which they appreciate those recorded as image and voice signals in a magnetic recording medium that is used in the form of a tape in, for example, a video movie camera.

In particular, U.S. Pat. No. 5,896,403 and U.S. Pat. No. 5,644,557 mentioned above disclose a dot code recorded as an optically readable voice code image on a printing medium such as a paper sheet, together with a photographed still image.

FIG. 1 illustrates the format of a dot code I as disclosed therein.

As shown, the dot code 1 consists of a plurality of blocks 2 arranged two-dimensionally. Each block 2 has a data area 3 in which white and black dots corresponding to respective values “0” and “1” obtained by dividing, in units of one block, data that indicates a voice are arranged in a predetermined manner; markers 5 arranged at the four corners of each block 2 for finding reference points to detect each dot (data dot 4) in the data area 3, each marker making of a predetermined number of black dots; and a block address pattern 6 arranged between each pair of adjacent markers and including an error detecting sign or an error correcting sign.

Even if the entire dot code 1 is larger than the imaging field of a reading means (not shown), its reading can be executed by manually moving the reading means on the code to sequentially pick up divided images of the code. In other words, even where the entire dot code 1 cannot be photographed at one time, the data of the entire code can be reconstructed if each address assigned to a corresponding one of the blocks 2 is read and recognized.

Accordingly, the above dot code can record voice information on, for example, a paper sheet, which cannot be realized by the conventional one- or two-dimensional bar code. This dot code is expected to be used as a future code image that will be particularly suitable for the photography image processing system.

However, a photography device for use in photography image processing systems has room for improvement.

That is, under an actual photography condition, a photographed still image and a voice code recorded on the same printing medium as that on which the still image is recorded are required to be reliably associated.

Interface this point is solved statistically, the photographed still image cannot be associated with the voice code image. Finally, an inconvenience that a desired photographed still image and the voice code image cannot be recorded on the same printing medium will occur.

A specific action concerning the above point is not disclosed in the above publications.

### BRIEF SUMMARY OF THE INVENTION

The present invention has been achieved in view of the foregoing points. It is an object of the present invention to provide a photography device and a printer used in a photography image processing system of such type so that a photographed still image and a voice code image recorded on the same printing medium as that on which the still image is recorded can be associated reliably and simply.

According to an aspect of the present invention, there is provided a photography device for use in a photography image processing system capable of recording an optically readable voice code image on a printing medium having a photography still image recorded thereon, comprising:

a voice input section for inputting a voice corresponding to the voice code image;

a digital conversion section for converting an input voice in the voice input section to digital voice data;

a voice data memory for storing the converted digital voice data by the digital conversion section; and

a relating data generating section for generating relating data for associating a photography still image and a voice code image recorded on the same printing medium,

wherein the voice data memory inputs the relating data generated by the relating data generating section, associates the input relating data with the associated voice data, and stores the relating data.

According to an another aspect of the present invention, there is provided a printer for use in a photography image processing system capable of recording an optically readable voice code image on a printing medium having a photography still image recorded thereon, comprising:

an input section for inputting image data corresponding to the photography still image;

a determination section for judging whether or not voice data to be recorded as the voice code image on the same printing medium together with the photography still image based on the image data is associated with image data input by the input section;

an instructing section for instruction a selection of whether or not the voice code image is recorded on the printing medium; and

a control section for, when the determination section determines that the voice data is associated with the image data, and when the instructing section instructs a selection for recording the voice code image on the printing medium, recording the photography still image and the voice code image on the same printing medium.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate presently preferred embodiments of the invention and, together with the general description given above and the detailed description of the preferred embodiments given below, serve to explain the principles of the invention.

FIG. 1 is a view illustrating a format of a dot code as a voice code image;

FIG. 2 is a block diagram useful in explaining the concept of a photography device according to the invention;

FIG. 3 is a view illustrating an arrangement of a voice code image and relating data on a printing medium on which a photographed still image is recorded;

FIG. 4 is a view illustrating another arrangement of a voice code image and relating data on a printing medium on which a photographed still image is recorded;

FIG. 5 is a view illustrating the structure of a silver film camera according to a first embodiment of a photography device of the invention;

FIG. 6 is a view showing a film as an image recording medium on which relating data and information related thereto are recorded;

FIG. 7A is a view showing the outward appearance of a front section of the silver film camera of the first embodiment;

FIG. 7B is a view showing the outward appearance of a rear section of the silver film camera of the first embodiment;

FIG. 8 is a view showing an information display liquid crystal panel;

FIG. 9 is a view showing a display in a finder;

FIG. 10 is a storage format used in a voice data memory;

FIG. 11 is a main flowchart useful in explaining the operation of a silver film camera according to a first embodiment;

FIG. 12 is a flowchart showing an operation mode setting processing shown in FIG. 11;

FIG. 13 is a flowchart showing a voice code recording position setting processing shown in FIG. 11;

FIG. 14 is a flowchart showing relating data setting processing shown in FIG. 11;

FIG. 15 is a flowchart showing a recording start processing shown in FIG. 11;

FIG. 16 is a flowchart showing a photography start processing shown in FIG. 11;

FIG. 17 is a flowchart showing a data output processing shown in FIG. 11;

FIG. 18 is a block diagram illustrating an electronic still camera according to a second embodiment of the photography device of the invention;

FIG. 19 is an external view showing a liquid crystal view finder;

FIG. 20 is a storage format used in an image data memory;

FIG. 21 is a view showing essential parts of the flowchart of the relating data setting processing in the second embodiment by extracting them;

FIG. 22 is a flowchart showing photography start processing when relating data is generated before photography in the second embodiment;

FIG. 23 is a flowchart for illustrating another example of photographic start processing when relating data is generated after photography in the second embodiment;

FIG. 24 is a flowchart showing data output processing in the second embodiment;

FIG. 25A to FIG. 25D are views each showing the layout of each region on a printing medium for illustrating an example of a template that designates the layout of each region on the printing medium;

FIG. 26 is a block diagram depicting a configuration of a printer according to one embodiment of the present invention;

FIG. 27 is a perspective view showing an appearance of the printer shown in FIG. 26;

FIG. 28 is an external view showing an operating switch panel;

FIG. 29A to FIG. 29C are a series of flowcharts for illustrating an operation of the printer shown in FIG. 26;

FIG. 30 is a view showing a display example of an information display LCD; and

FIG. 31 is a view showing a display example of an image display color LCD.

### DETAILED DESCRIPTION OF THE INVENTION

The concept of the present invention will be explained before describing the embodiments of the invention in detail.

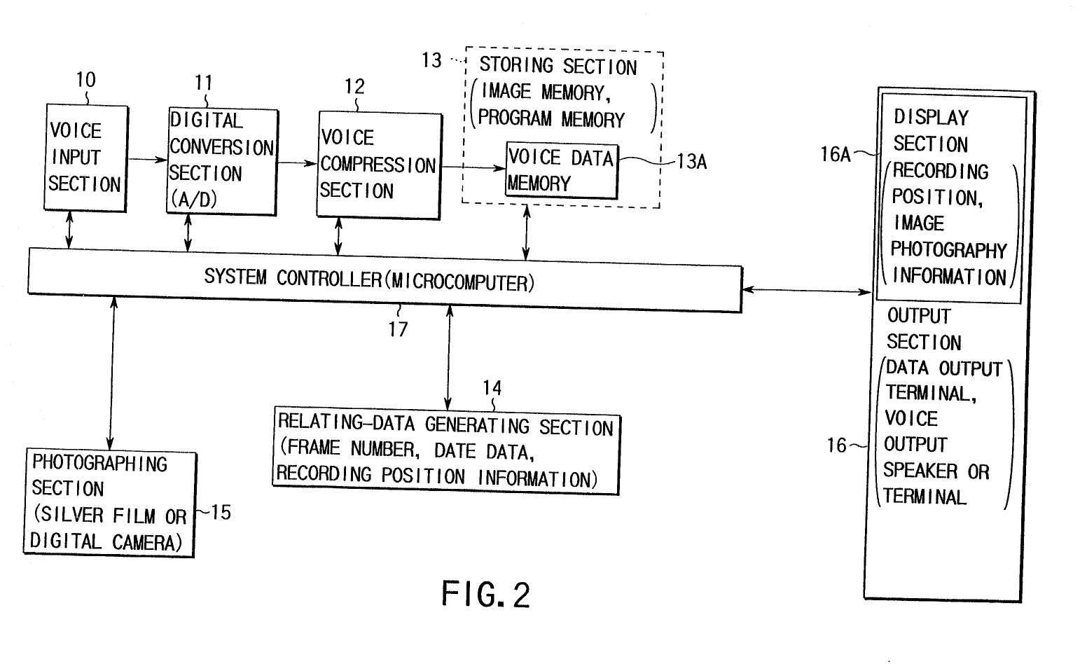

As is shown in FIG. 2, a photography device according to the invention comprises a voice input section 10, a digital conversion section 11, a voice compression section 12, a storing section 13, a relating-data generating section 14, a photographing section 15, an output section 16 and a system controller 17.

In the photography device of the invention, a voice input through the voice input section 10 and corresponding to a voice code image is converted into a digital voice signal by the digital conversion section 11, then compressed by the voice compression section 12, and stored as voice data in the storing section 13. Further, the relating-data generating section 14 generates data for relating, to each other, a photographed still image and a voice code image recorded on the same printing medium. The storing section 13 stores the generated data in relation to voice data related thereto.

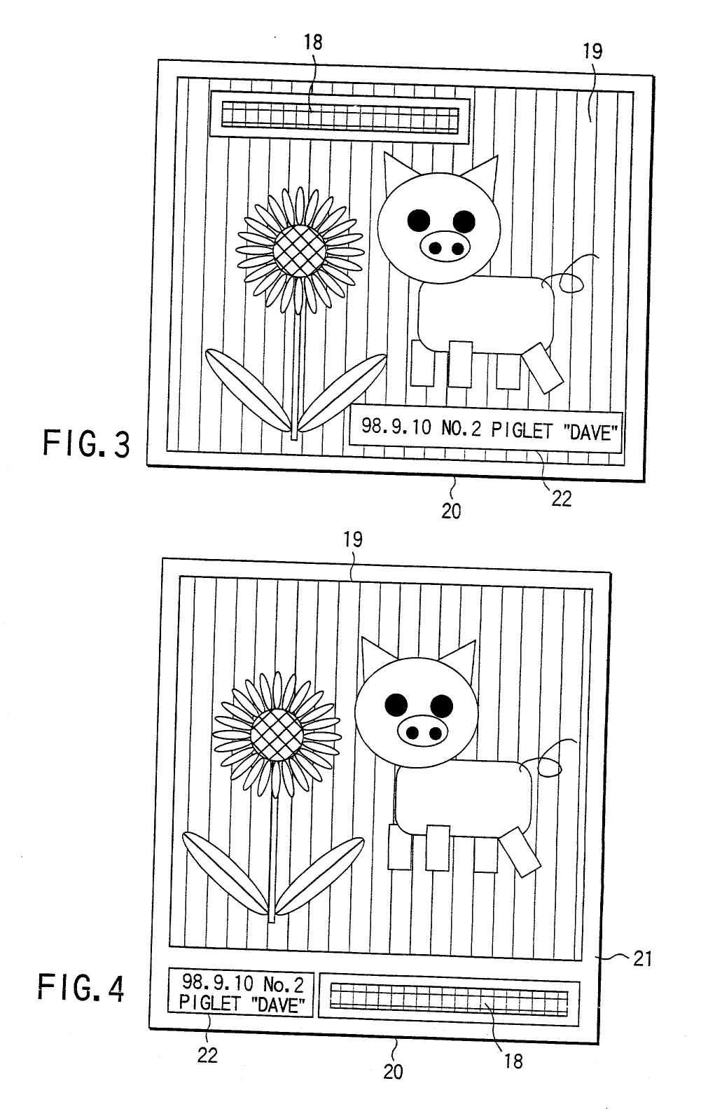

The photography device of the invention is used in a photography image processing system that can record an optically readable voice code image 18 on a printing medium 20 on which a photographed still image 19 is recorded, as shown in FIG. 3 or 4. FIG. 3 shows a case where the voice code image 18 and the relating data are recorded in the photographed still image 19. FIG. 4 shows a case where the voice code image 18 and the relating data are recorded in a margin 21 of a printing medium. The margin 21 may be defined beforehand in the printing medium outside an area for the photographed still image 19, or may be formed outside the image 19 when recording the image 19.

The relating data is used to relate, to each other, the voice code image 18 and the photographed still image 19 which are to be recorded on the same printing medium 20, and is recorded in a relating-data recording section 22 together with information thereon. In FIGS. 3 and 4, “No. 2” out of “198.9.10 No. 2 Piglet ‘Dave’” is the relating data and indicates the frame number of the photographed still image 19. Further, date “98.9.10” and letters “Piglet ‘Dave’” indicate the information concerning the relating data. The letters “Piglet ‘Dave’” can be replaced, by the relating-data generating section 14, with any other letters such as the name of a place that the photographer visited. The relating-data generating section 14 also generates recording position information, as information concerning the relating data, which indicates the position in which the voice code image 18 is recorded and the position optionally designated by the relating-data recording section 22, thereby storing it in the storing section 13.

The photographing section 15 has a similar photographing mechanism to a known silver film camera or to a known electronic still camera called a digital camera. Where the photography device of the invention is applied to a silver film camera, the storing section 13 is formed as a voice data memory 13A fixed or detachably installed in the camera. On the other hand, where the photography device of the invention is applied to an electronic still camera, the storing section 13 is formed of a fixed or detachable image data memory, which is usually installed in the electronic still camera. Instead of the voice data memory 13A or the image data memory, a program memory can be used which stores operation programs for the system controller 17 as a microcomputer.

The output section 16 is formed of a data output terminal for outputting, to the outside, the voice data, the relating data and information associated therewith which are stored in the storing section 13, or is formed of a voice outputting speaker or terminal for outputting the voice data. The output section 16 includes a display section 16A, and hence can display image photography information such as focusing, or display a recording position so that the photographer can designate any optional position when the relating-data generating section 14 generates the recording position information.

The present invention can be constructed so that a voice compression section 12 in FIG. 2 is omitted, and a storing section 13 directly stores digital voice data converted by the digital conversion section 11.

Hereinafter, embodiments of the present invention will be described with reference to the accompanying drawings.

[First Embodiment of Photography Device]

FIG. 5 shows the structure of a silver film camera 100 of a photography device according to a first embodiment of the invention.

An analog signal is input through a voice input circuit 101 (corresponding to the voice input section 10) including a microphone and an auto gain control (AGC) amplifier, then subjected to known signal processing, and converted into a digital data by an A/D converter circuit 102 corresponding to the digital conversion section 11. The resultant digital data is input to a voice compression/expansion circuit 103 constituted of a digital signal processor (DSP) and corresponding to the voice compression section 12, where the signal is subjected to voice compression processing. The compressed digital voice data is read by a system controller 104 constituted of a micro-computer and corresponding to the system controller 17, and is written into a voice data memory 105 corresponding to the voice data memory 13A.

The voice data memory 105 may be of a fixed type or of a detachable type such as a memory card. In FIG. 5, the case of using the detachable type memory is indicated by the broken lines.

This embodiment employs means for reproducing the contents of digital voice data stored in the voice data memory 105,to enable the user to confirm them. When executing reproduction and confirmation, the system controller 104 accesses the voice data memory 105, thereby reading digital voice data stored therein, executing expansion processing using the voice compression/expansion circuit 103, and returning the resultant data to a voice signal using a D/A converter circuit 106. After that, a voice output circuit 107 which corresponds to part of the output section 16 amplifies the signal using, for example, a power amplifier, and outputs a reproduced sound, using a speaker or an earphone for converting an electric signal to a sound pressure.

The system controller 104 is connected to a program memory 108 that stores operation programs for the system controller 104, and also to a data memory 109 to be used when executing various processes.

The system controller 104 is further connected to an operation mode setting section 110 and a relating-data setting section 111.

The operation mode setting section 110 is formed of switches to be used by the user to designate various operation modes. The operation modes include, for example, a setting mode for setting whether the setting of, relating data should be executed manually or automatically, and an output mode for setting whether, for example, voice data or relating data stored in the voice data memory 105 should be output, and the like.

The relating-data setting section 111 is formed of, for example, switches to be used for inputting the relating data and information such as comments on the relating data. Where, for example, the operation mode setting section 110 sets a mode for manually setting the relating data, the relating-data setting section 111 sets a frame number as the relating data to be made to correspond to voice data when the voice data is stored in the voice data memory 105. When such setting has been executed using a switch, the system controller 104 causes the relating-data generating section 104A (corresponding to the relating-data generating section 14) to create relating data corresponding to the input frame number, and to store it in the voice data memory 105 in relation to the voice data.

The system controller 104 is connected to an exposure-level detecting/controlling section 112, a focus detecting/controlling section 113, a date recording section 114, a clock circuit 115, a frame number detecting section 116, an image photography information display section 117 and an image-recording-medium feeding section 118. These sections are similar to those employed in an already known silver film camera. The image photography information display section 117 corresponds to part of the display section 16A, and the other sections correspond to the photographing section 15.

The exposure-level detecting/controlling section 112 executes an AE operation, while the focus detecting/controlling section 113 executes an AF operation. In accordance with the results of the AE and AF operations, the system controller 104 causes the image photography information display section 117 such as a finder to display a warning message concerning exposure or a message concerning focusing. Further, the controller 104 reads date information from the clock circuit 115, and causes the date recording section 114 to print the date on a film as the image recording medium 119. Each time an photographing operation is executed, the image recording medium feeding section 118 winds the film, and the frame number detecting section 116 increases the number of frames by “1” in accordance with the winding operation.

Where the operation mode setting section 110 sets a mode in which the relating data is automatically set, the relating-data generating section 104A sets, as the relating data, the frame number detected by the frame number detecting section 116, and stores it in the voice data memory 105. The frame number detecting section 116 may be provided in the system controller 104.

The system controller 104 is connected to a recording position setting section 120 and a recording position display section 121 corresponding to part of the display section 16A. The recording position setting section 120 consists of switches for enabling the user to designate the positions of the voice code image 18 and the relating-data recording section 22 in the printing medium 20. The recording position display section 121 displays these positions to enable the user to confirm them.

The system controller 104 is also connected to a data output terminal 122 corresponding to part of the output section 16.

Since the photography device in this embodiment is a silver camera, it is necessary to transmit image information recorded in a film as the image recording medium 119, and voice data stored in the voice data memory 105 to a photograph laboratory system 200, in order to subject the voice code image 18 and the photographed still image 19 to processing for actually recording them on the printing medium 20. To this end, the system controller 104 reads the voice data, the relating data and information associated therewith from the voice data memory 105, and transmits them to the photograph laboratory system 200 through the data output terminal 122 via, for example, a connection cable. The image recording medium (film) 119 is physically brought into the photograph laboratory system 200, as in the conventional case.

In the case where the voice data memory 105 is of the fixed type, it is necessary to bring the camera itself into the photograph laboratory system 200. However, in the case where the memory 105 is formed of, for example, a detachable memory card, it suffices if the voice data memory 105 and the film are brought together into the photograph laboratory system 200.

Thus, a pair of vice data and relating data are brought into the photograph laboratory system 200. In the system 200, an external control device 201 detects the data to create the voice code image 18, and an external printing device 202 prints it on a printing medium together with the frame numbers of the film.

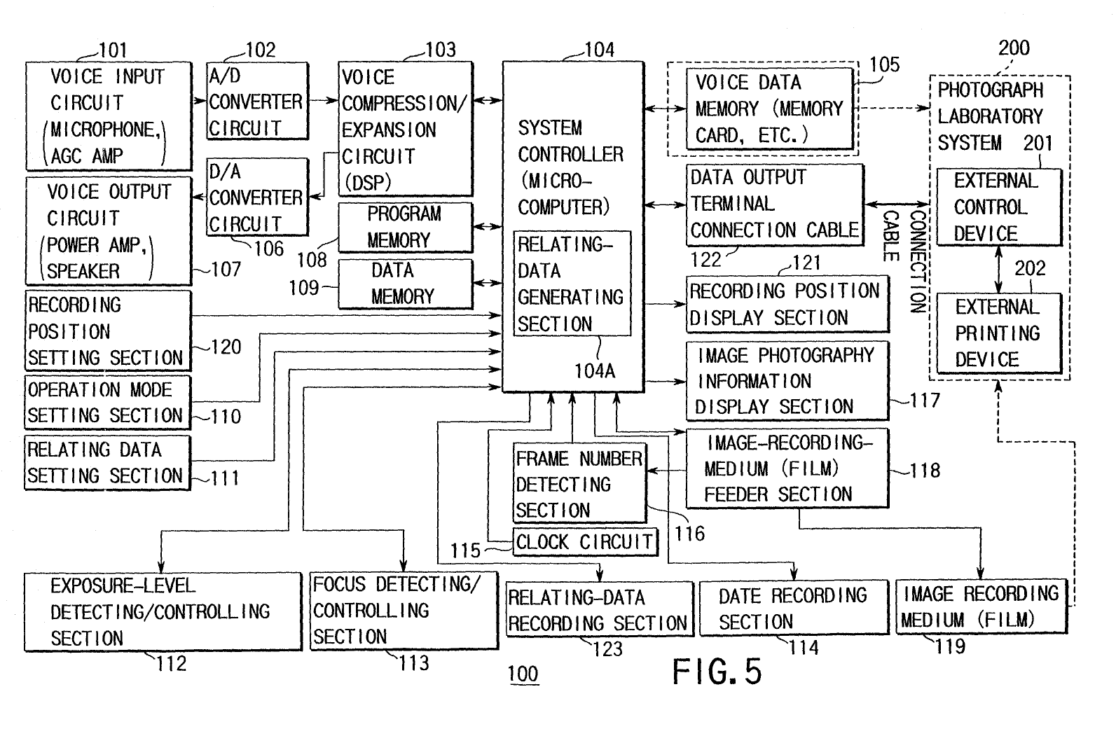

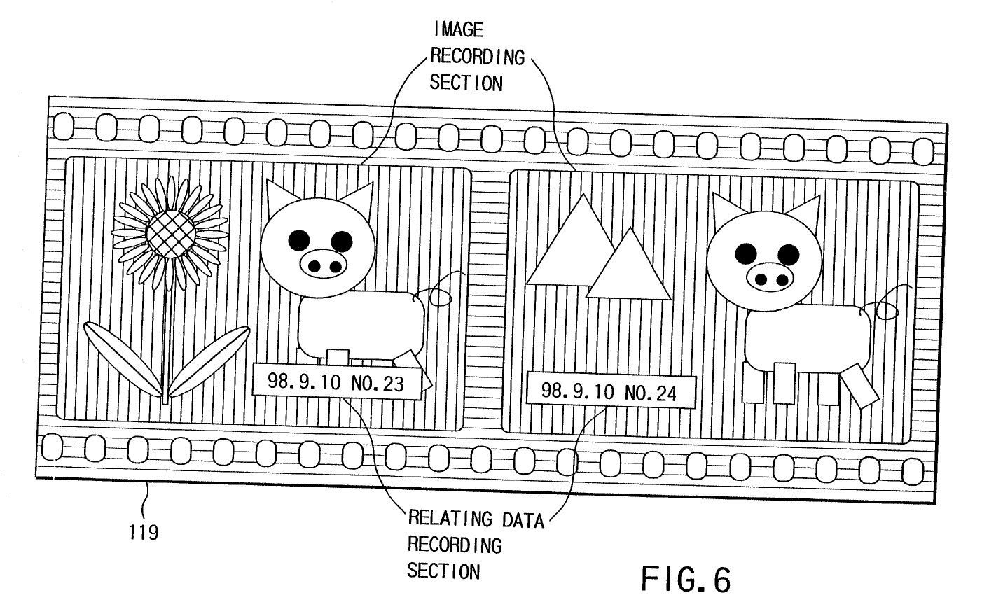

The silver film camera 100 may have a relating-data recording section 123. In the above explanation, the voice code image 18 and the relating data are printed on a photographic paper sheet as the printing medium 20. The relating data, however, can be printed directly on a film as the image recording medium 119. For example, by using an exposure system for optically focusing a dot matrix liquid crystal panel with a backlight, as in the date recording section 114, relating data and information associated therewith is directly exposed on the image recording medium (film) 119 as shown in FIG. 6. In this case, in order to secure an area for recording the voice code image 18, this area may be exposed in white.

Relating data generated by the relating-data generating section 104A is temporarily stored in the data memory 109. When recording the relating data on a film, the relating-data recording section 123 reads and records the memory contents temporarily stored in the data memory 109. The relating data temporarily stored in the data memory 109 is finally stored in the voice data memory 105 in relation to voice data.

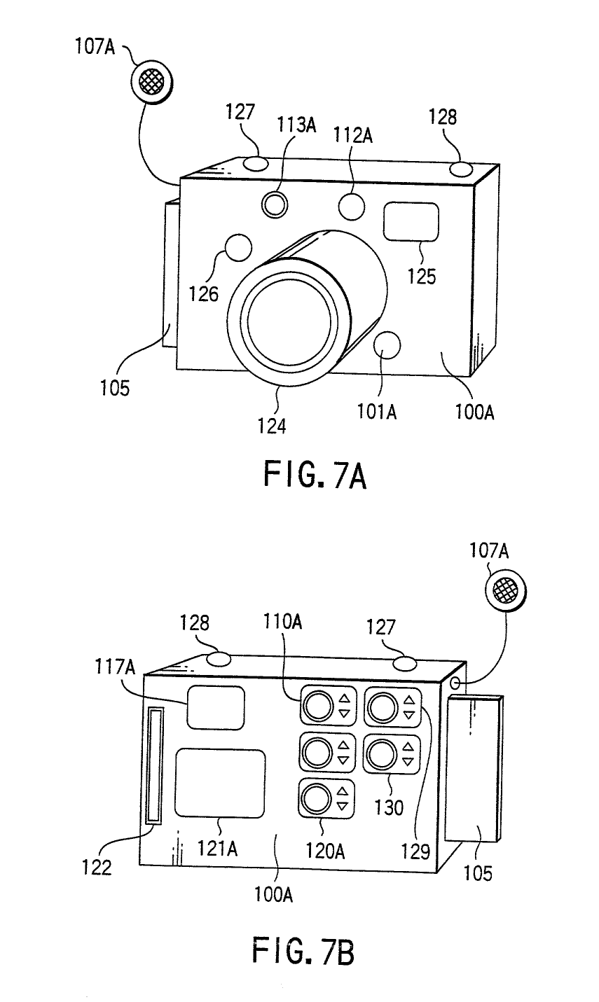

Referring to FIGS. 7A and 7B, the outward appearance of the silver film camera 100 in this embodiment will be described.

As is shown in FIG. 7A, a lens 124, a finder 125, an exposure level detecting section 112A, a focus detecting section 113A and a self-timer lamp 126, etc. are provided on the front surface of a camera body 100A, as in conventional cameras. A photography start button 127 is provided on the upper surface of the body 100A.

Further, the present invention is characterized in that a microphone 101A for inputting a voice is provided on the front surface of the camera body 10A, that a manual recording start button 128 for instructing a start of voice recording at any timing is provided on the upper surface, and that a voice data memory (if the memory is of a detachable type, it is formed of a memory card) 105 for storing voice data and a voice confirming earphone 107A are provided on a side surface of the body 10A. The self-timer lamp 126 also serves as a lamp for displaying a recording period. The recording period is optionally set using the operation mode setting section 110, or automatically determined in accordance with the set length of a recorded voice code image.

Although the microphone 101A is provided on the front surface of the camera body 100A, i.e. on the lens side, it is a matter of course that the microphone may be located on the rear surface. In the case of locating the microphone on the lens side, the voice of a to-be-photographed person can be recorded, while in the case of locating it on the rear surface, the photographer can record their comments. If the microphone is of an omnidirection type, the same effect will be obtained irrespective of whether the microphone is located on the front surface or on the rear surface.

As shown in FIG. 7B, the rear surface of the camera body 101A is provided with the data output terminal 122, an information display liquid crystal panel 121A as the recording position display section 121 and various buttons, as well as a usual finder 117A. The buttons include an operation mode setting button 110A as the operation mode setting section 110, a relating-data setting button 111A as the relating-data setting section 111, a recording position setting button 120A as the recording position setting section 120, a voice selection/reproduction button 129 for instructing a selection and reproduction of voice data stored in the voice data memory 105, an image selection button 130 for designating an image to be related to voice data, and the like. Incidentally, it is possible to prepare one button serving as both the voice selection/reproduction button 129 and the image selection button 130.

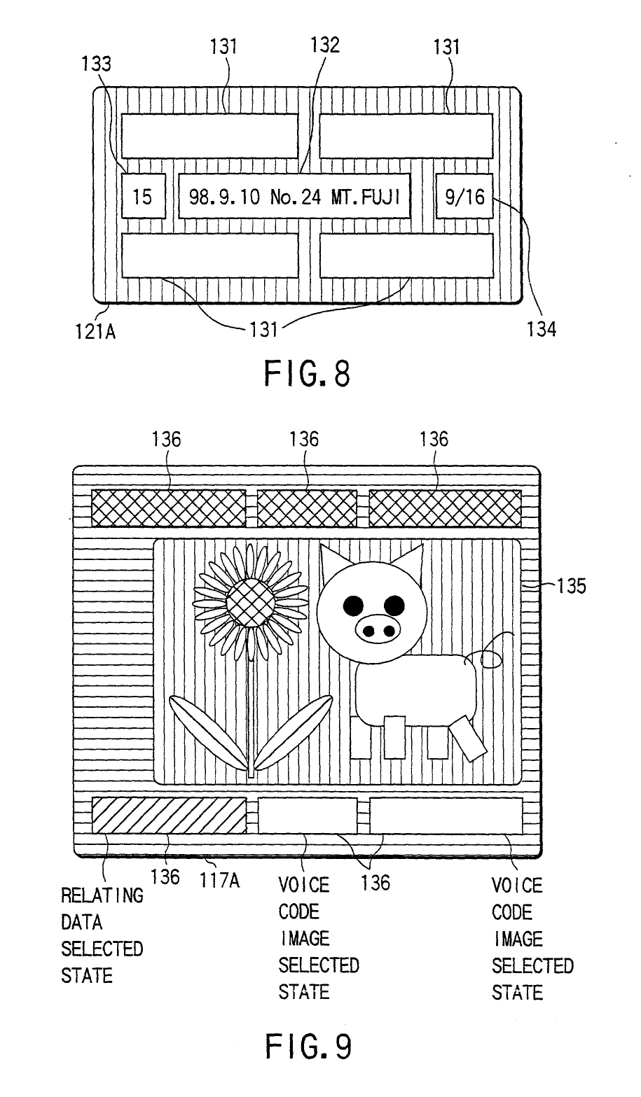

As shown in FIG. 8, the information display liquid crystal panel 121A comprises four recording position display sections 131 for displaying recording positions of the voice code image 18, a relating-data contents display section 132 for displaying relating data and information associated therewith, a recordable period display section 133 and a designated registration number/recorded number display section 134.

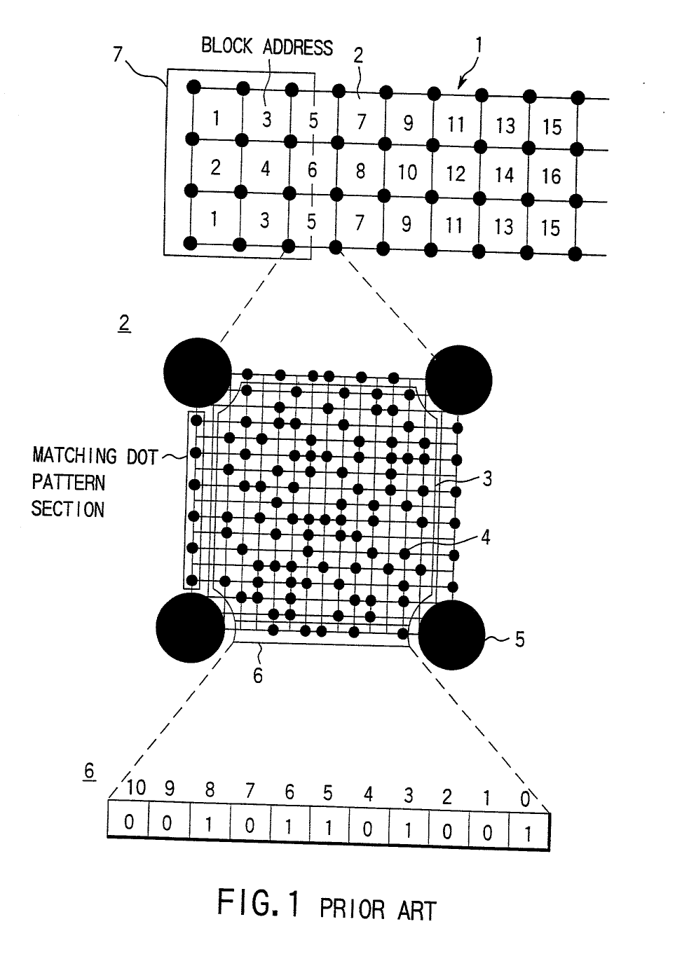

The recording position display sections 131 indicate positions where the voice code image 18 can be recorded. The photographer can optionally designate one or more of the positions, using the recording position setting button 120A. The designated position is lit to indicate the recording position of the image 18. Here, when recording a large amount of voice data, it is considered to record the voice code image 18 in a long lower portion of the printing medium 20. In this case, both the lower right and left recording position display sections 131 are lit. Further, if the voice code image 21 is in the form of a dot code of a dividable block address system as shown in FIG. 1, original voice data can be reproduced by reading all data, even when the data is divided into upper and lower portions. Therefore, in this case, it is possible that the voice code image 21 will be divided into two rows and the upper two display sections and the lower two display sections will be lit.

The relating-data contents display section 132 displays relating data (“No. 24” as a frame number in FIG. 8) set by the relating-data setting button 111A or set automatically. The section 132 also displays information associated with the relating data (date information “98.9.10” and comments “MT. FUJI”).

The recordable period display section 133 displays a recordable period which is optionally set, using the operation mode setting section 110, or determined in accordance with a set recording period of the voice code image. The designated registration number/ recorded number display section 134 displays the number of recorded voice data stored in the data memory 105 and voice data to be related to the photographed still image in the recorded voice data or voice data to be reproduced.

The finder 117A is an optical finder. As shown in FIG. 9, in the finder, six LEDs 133 for displaying the recording positions of voice code image-relating data are arranged, three above and three below an optical image display section 135 for observing a to-be-photographed subject obtained via an optical system (not shown).

The LEDs 136 each can display both the recording positions of the voice code image 18 and the relating data recording section 22. Whether the image 18 or the relating data is recorded can be determined from the color or the brightness of the light of each LED. For example, in FIG. 9, that no voice code image 18 or relating data will be recorded in an upper portion is indicated by turning off the upper three LEDs 136. On the other hand, that the voice code image 18 will be recorded in lower middle and right portions is indicated by lighting the lower middle and right LEDs 136 in a first color. Furthermore, that relating data will be recorded is indicated by lighting the lower left LED 136 in a second color, or by lighting the LED in the first color but more weakly.

Since the finder 117A has a small area, the contents of the relating data are not displayed in this embodiment. However, it is a matter of course that they may be displayed.

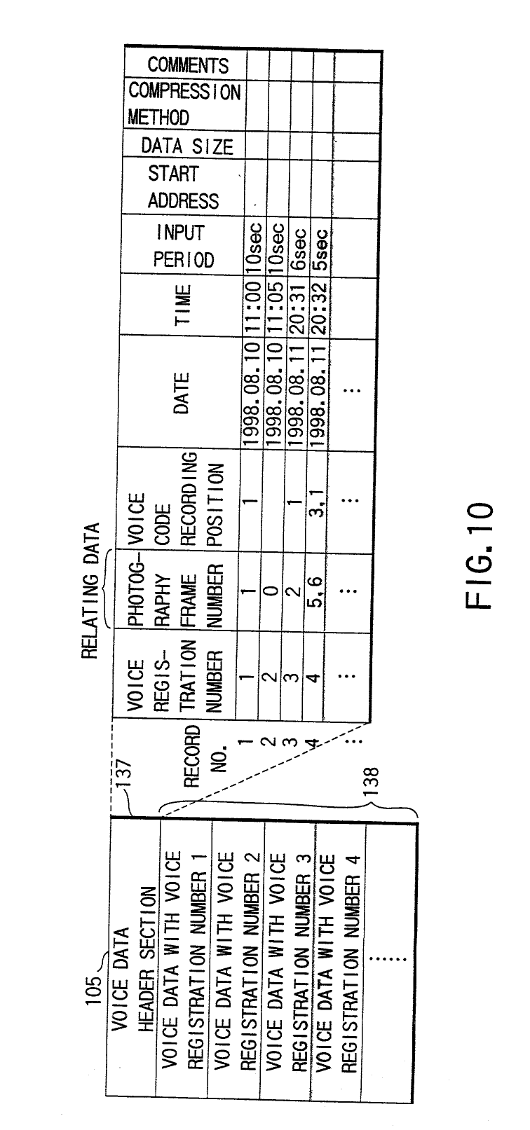

Referring then to FIG. 10, a storage format used in the voice data memory 105 will be described.

The voice data memory 105 mainly comprises a voice data header section 137 and a voice data storage section 138. The voice data storage section 138 stores each voice data item input through the microphone 101A, while the voice data header section 137 stores registration information concerning each of input voice data items.

Specifically, the voice data header section 137 stores, as one record for each voice data item, a voice registration number, a photography frame number, a voice code recording position, a date, a time, an input time period, a start address, a data size, a compression method, comments, etc.

The voice registration number is provided for identifying each voice data item. Although this number is expressed by a numeral, but it is not limited thereto. The frame number corresponds to the relating data. Frame number “0” indicates that there is no relating data, and frame number “5, 6” indicates that a single voice code image stretches over a plurality of images. The voice code recording position indicates, using a numeral (numerals), the portion(s) of a recording medium on which each voice code image is printed.

Now, an operation of a silver film camera 100 in the above construction will be described with reference to a flowchart showing an operating program stored in a program memory 108 to be executed by a system controller 104.

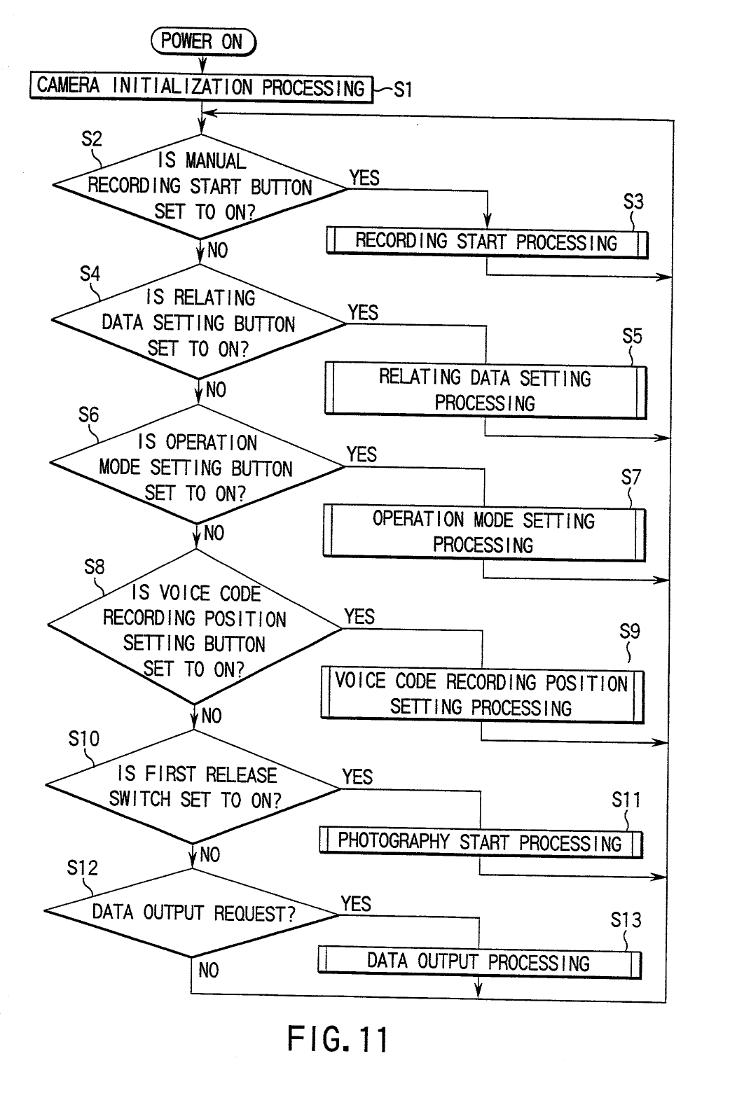

FIG. 11 is a main flowchart showing that, when power is supplied, camera initialization processing is first performed (step S1).

Then, it is determined whether or not a manual recording start button 128 has been turned ON (step S2). When the button is turned ON, recording start processing as described later in detail is performed (step S3), and then, processing returns to the step S2.

In addition, when it is not determined that the manual recording start button 128 is not turned ON, it is determined whether or not a relating data setting button 111A has been turned ON (step S4). When the button is turned ON, relating data setting processing as described later in detail is performed (step S5), and processing returns to the step S2.

When it is determined that the relating data setting button 111A is not turned ON, it is then determined whether an operation mode setting button 110A has been turned ON (step S6). When the button is turned ON, operation mode setting processing as described later in detail is performed (step S7), and processing returns to the step S2.

When it is determined that the operation mode setting button 110A is not turned ON, it is determined whether or not a voice code recording position setting button 120A has been turned ON (step S8). When the button is turned ON, voice code recording position setting processing as described later in detail is performed (step S9), and processing returns to the step S2.

When it is determined that the voice code recording position setting button 120A is not turned ON, it is then determined whether or not a first switch (SW) of a photography start button 127, so called a first release SW has been turned ON (step S10). When the switch is turned ON, photography start processing as described later in detail is performed (step S11), and processing returns to the step S2.

When it is determined that the first release SW of the photography start button 127 is not turned ON, it is then determined whether or not a data output request is given from an external control device 201 of a photography laboratory system 200 via a data output terminal 122 (step S12). When this request is given, data output processing as described later in detail is performed (step S13), and processing returns to the step S2. In addition, when such data output request is not given, processing returns to the step S2.

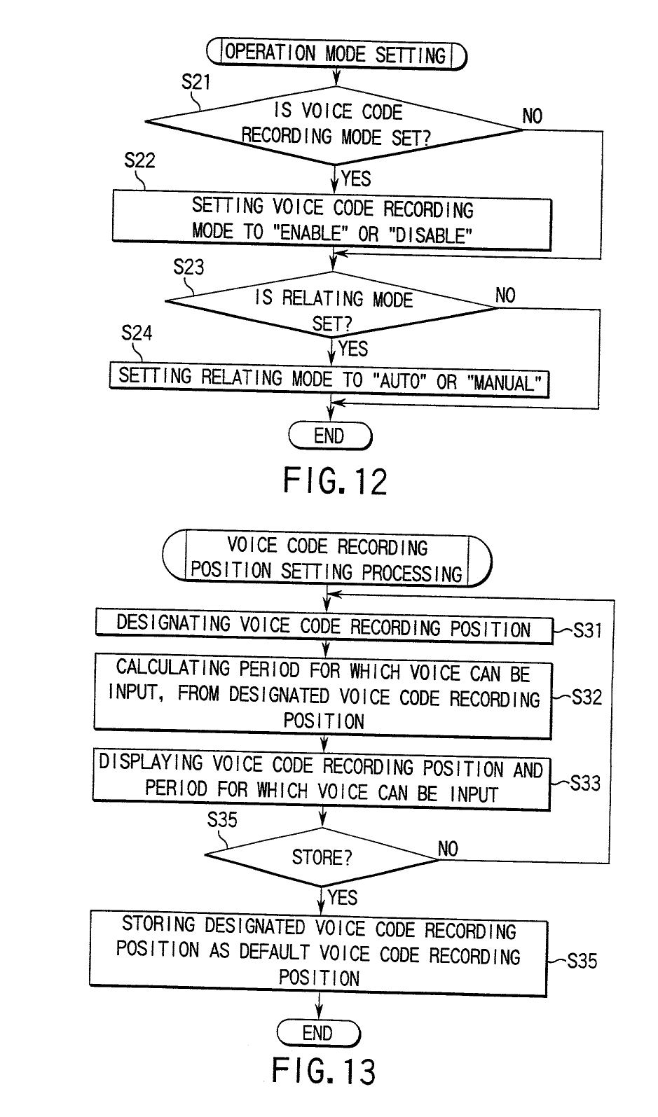

FIG. 12 is a flowchart showing operation mode setting processing to be executed in the step S7. This operation mode setting processing is for setting mode of the entire system.

That is, it is first determined whether or not an operation using the operation mode setting button 110A is for setting voice code recording mode (step S21). When it is, voice code recording mode is set to “Enable” or “Disable” according to that operation (step S22). Then, or when it is determined that the above operation is not for setting voice code recording mode in the step S21, it is determined whether or not an operation using the operation mode setting button 110A is for setting relating mode (step S23). When the above operation is not for setting relating mode, the operation mode setting processing is terminated, and processing returned to the main routine. In contrast, when the operation is for setting relating mode, relating mode is set to “Auto” or “Manual” according to that operation (step S24), and processing returned to the main routine.

FIG. 13 is a flowchart showing voice code recording position setting processing to be executed in the step S9. This voice code recording position setting processing is for storing a default recording position.

That is, a voice code recording position is first designated according to an operation of the voice code recording position setting button 120A (step S31). Next, a voice period that can be input depends on this designated voice code recording position, and thus, the voice period is calculated (step S32). The thus designated voice code recording position is displayed on the information display liquid crystal panel 121A and the finder 117A. In addition, the thus calculated voice period that can be input is displayed on the information display liquid crystal panel 121A (step S33).

As a result of the user observing that display, it is determined whether or not a predetermined storage instructing operation has been made (step S34). When this storage instructing operation is not made, namely, when an attempt is made to retry setting, processing returns to the step S31. In contrast, when a storage instructing operation is made, the above designated voice code recording position is temporarily stored as a default voice code recording position in the data memory 109 (step S35), and processing returns to the main routine.

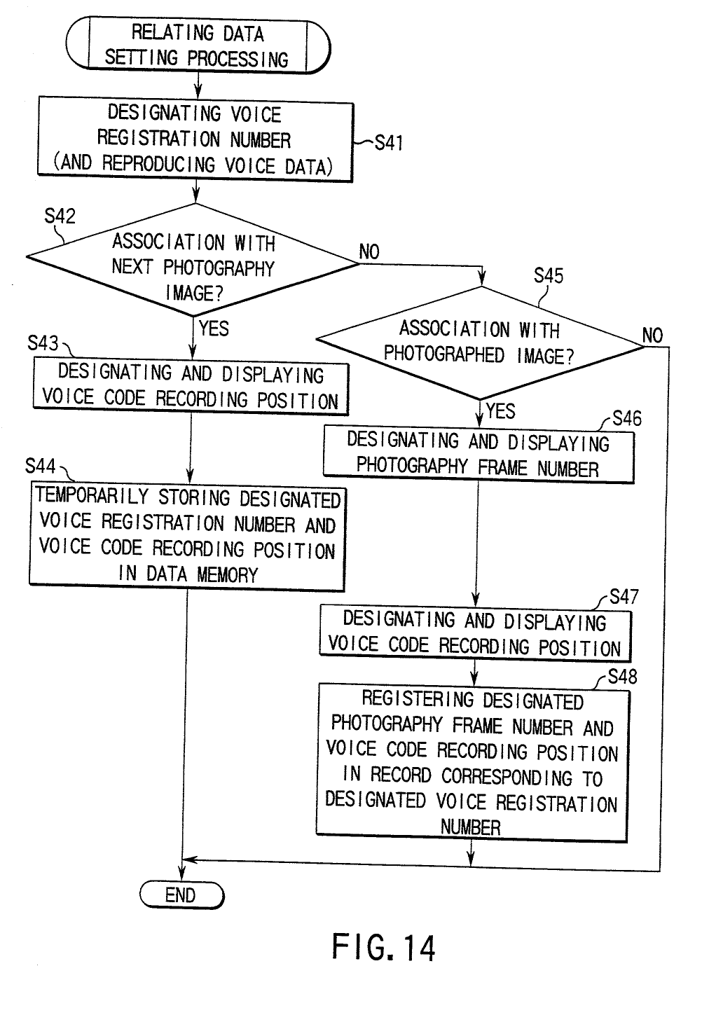

In addition, relating data setting processing to be executed in the step S5 is performed as shown in FIG. 14. This is an operation when “Manual”, mode is set in the above operation mode setting processing.

That is, when this relating data setting processing is called according to an operation of the relating data setting button 111A, a voice registration number of voice data that has already been registered in the voice data memory 105 is designated according to an operation of the voice selection/reproduction button 129 that has been subsequently made (step S41). At this time, that voice data may be reproduced and checked as required.

Then, it is determined whether or not the voice data corresponding to that designated voice registration number will be associated with a next photography image (step S42).

In the case of association with the next photography image, a voice code recording position is designated by operation of the recording position setting button 120A. The thus designated position is displayed on the information display liquid crystal panel 121A and in the finder 117A (step S43). Then, the thus designated voice registration number and voice code recording position are temporarily stored in the data memory 109 (step S44), and processing returns to the main routine.

In addition, when it is determined that the voice data corresponding to the designated voice registration number is not associated with the next photography image in the step S42, it is further determined whether or not the voice data will be allocated to a photographed image (step S45). Otherwise, processing returns to the main routine.

In contrast, when voice data will be allocated to a photographed image, a photography frame number is designated as relating data by operation of the image selection button 130. The thus designated photography frame number is displayed on the information display liquid crystal panel 121A (step S46). A voice code recording position is designated by operation of the recording position setting button 120A, and the thus designated position is displayed on the information display liquid crystal panel 121A and in the finder 117A (step S47). The designated photography frame number and voice code recording position are recorded in the record of the voice data header section 137 of the voice data memory 105 corresponding to the designated voice registration number. Namely, the voice data header section 137 has been rewritten (step S48). Thereafter, the relating data setting processing is terminated, and processing returns to the main routine

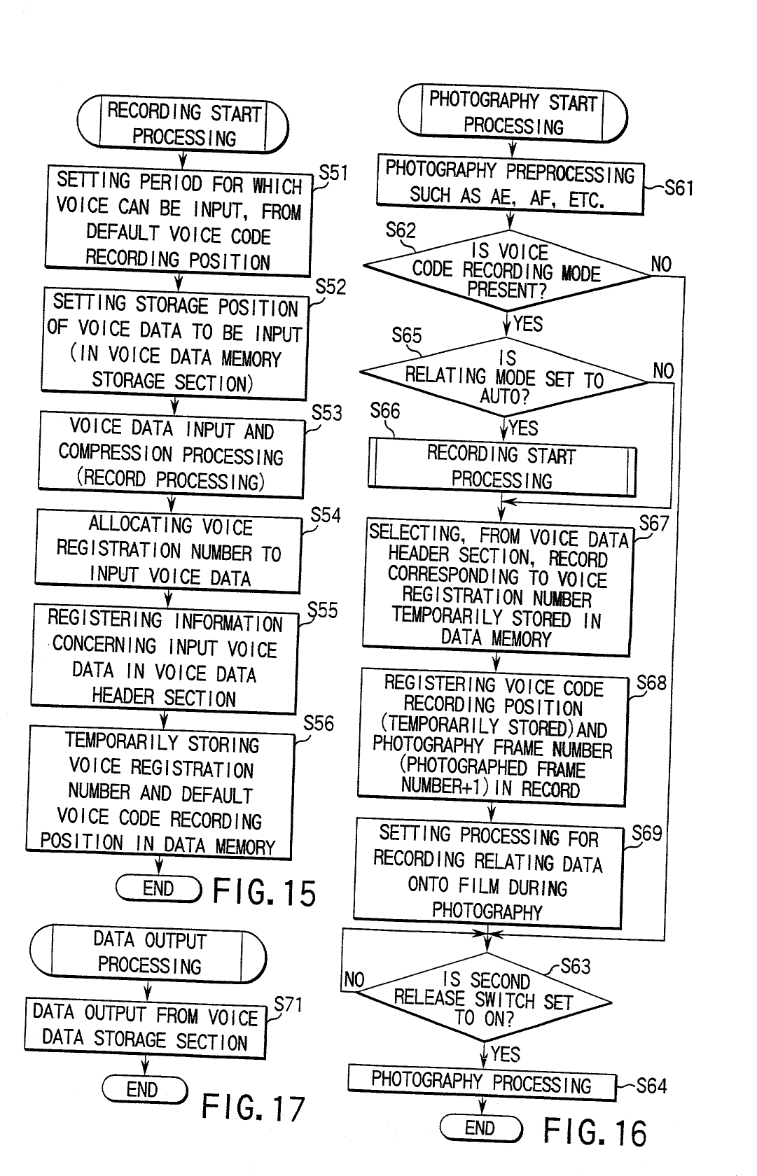

Now, recording start processing to be executed in the step S3 will be described with reference to a flowchart shown in FIG. 15.

That is, first, a period for which voice can be input is set according to a default voice code recording position set in the voice code recording position setting processing (step S51). Further, it is set as to which position in the voice data storage section 138 of the voice data memory 105 to store voice data to be input (step S52). Then, voice data input from the microphone 101A and compression processing using the voice compression/decompression circuit 103, that is, recording processing is performed, and the data is stored in the above set storage position of the voice data memory 105 (step S53). A voice registration number is allocated to this input voice data, whereby the record of the voice data header section 137 of the voice data memory 105 is added (step S54). Next, information concerning the voice data, that is, date, time, input period or the like is registered in that record of the voice data header section 137 (step S55). The allocated voice registration number and the default voice code recording position are temporarily stored in the data memory 109 (step S56). Namely, at this stage, association with image is not performed yet. Then, the recording start processing is terminated, and processing returns to the main routine.

Now, photography start processing to be executed in the step S11 will be described with reference to a flowchart shown in FIG. 16.

That is, when this processing is called by turning ON the first release SW of the photography start button 127, photography preprocessing such as known AE and AF is first executed (step S61). Then, it is determined whether or not voice code recording mode set in the above operation mode setting processing is set to “Enable” (step S62).

Here, when the voice code recording mode is set to “Disable”, the second switch of the photography start button 127, so called a second release SW is ready to be turned ON (step S63). When this switch is turned ON, the known photography processing is performed (step S64), and processing returns to the main routine.

On the other hand, when it is determined that voice code recording mode is set to “Enable” in the step S62, it is further determined whether or not the relating mode set in the above operation mode setting processing is set to “Auto” (step S65). When the relating mode is set to “Auto”, recording start processing similar to that in the step S3 is executed (step S56). When the mode is set to “Manual”, processing in the step S66 is skipped. That is, in the case of “Manual”, the voice registration number and voice recording position are temporarily stored in the data memory 109 by the above relating data setting processing. In the case of “Auto”, at a stage at which this recording start processing has terminated, the above number and position are temporarily stored in the data memory 109.

Therefore, the record of the voice data header section 137 of the voice data memory 105 is then selected according to the voice registration number temporarily stored in the data memory 109 (step S67). Similarly, the voice code recording position temporarily stored in the data memory 109 and a photography frame number that is “photographed frame number +1” are registered in that selected record (step S68). Then, the setting processing for recording relating data onto a film as the image recording medium 119 on actual photography is performed (step S69). Thereafter, processing proceeds to the step S63, and, in response to the ON setting of the second release SW of the photography start button 127, the known photography processing is performed in the step S64. However, in this case, the relating data set in step S69 is recorded on a film by means of a relating data recording section 123.

Data output processing in step S13 is directed to processing (step S71) for outputting the data of the voice data storage section 138 of the voice data memory 105 from the data output terminal 122 as shown in a flowchart of FIG. 17.

[Second Embodiment of Photography Device]

Now, a case in which the photography device according to the present invention is applied to an electronic still camera will be described according to a second embodiment.

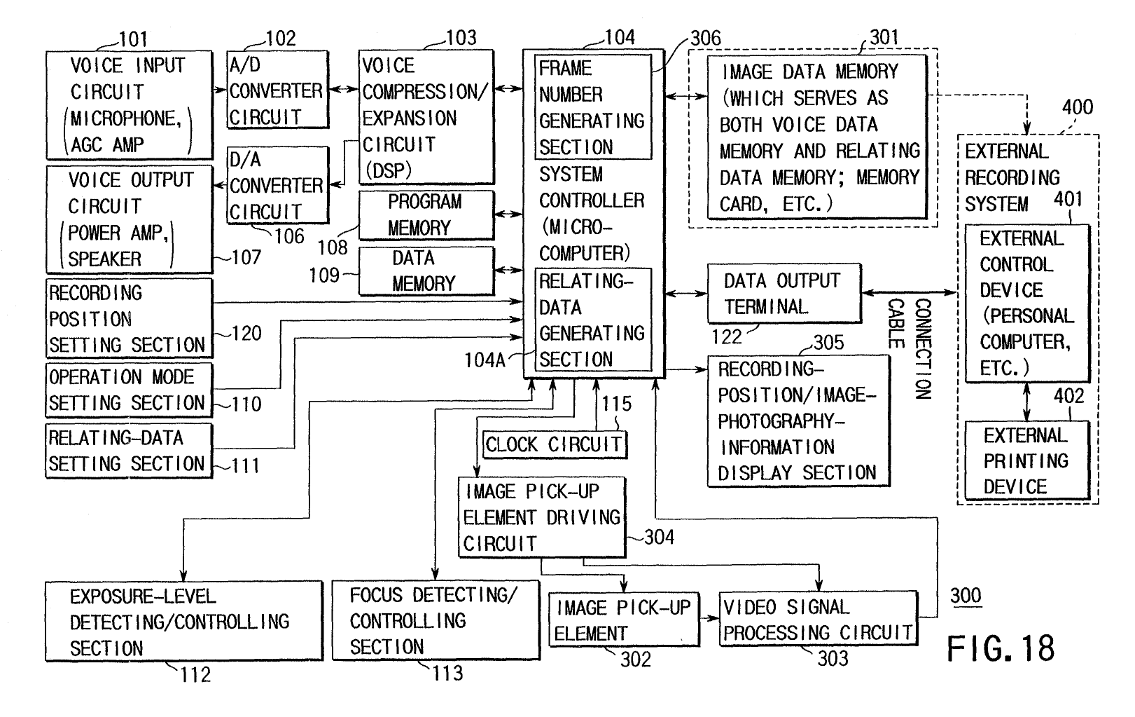

FIG. 18 shows a structure of an electronic still camera 300. In the figure, similar elements to those of the silver film camera 100 described in the first embodiment are designated by corresponding reference numerals, and hence a detailed description will not be given thereof but only of different elements.

The electronic still camera 300 inherently incorporates an image data memory 301 for storing a photographed image. Accordingly, in this embodiment, it is not necessary to employ any particular memory like the voice data memory 13A for storing voice data, relating data and information associated therewith. The image data memory 301 also functions as the voice data memory 13A. Of course, the image data memory 301 may be of the fixed type or the detachable type.

Further, since the electronic still camera 300 does not use a film, it does not have a photographing mechanism for the film and a film feeding mechanism. Instead, it has an image pick-up element 302 as typified by a charge coupled device for picking up image data, a video signal processing circuit 303 for converting a video signal output from the image pick-up element 302, into color and brightness signals or an RGB signal, thereby supplying the system controller 104 with the signal as a digital image signal, and an image pick-up element driving circuit 304 for driving the image pick-up element 302.

The camera 300 also has a recording-position/ image-photography-information display section 305 consisting of a single large view finder, instead of the image photography information display section 117 (the finder 117A) and the recording position display section 121 (the information display liquid crystal panel 121A). However, similarly to the first embodiment, it is a matter of course that the camera 300 may incorporate the image photography information display section 117 (the finder 117A) and the recording position display section 121 (the information display liquid crystal panel 121A), as in the silver film camera 100.

Further, in this embodiment, the system controller 104 includes a frame number creating section 306 for creating a photography frame number used as relating data. The section 306 creates a frame number in accordance with each photographing operation of the image pick-up element 302.

Since the electronic still camera 300 is usually used personally, a domestic external recording system 400 is used for printing image information and voice code images. The domestic external recording system 400 consists of an external printing device 402 which is, for example, a printer connected to an external control device 401 such as a personal computer, or which is dedicated printer that can be directly connected to the image data memory 301. However, the number of digital image laboratories is increasing these days, and therefore image information and voice code images created by the electronic still camera 300 may be printed in such laboratories as in the aforementioned case.

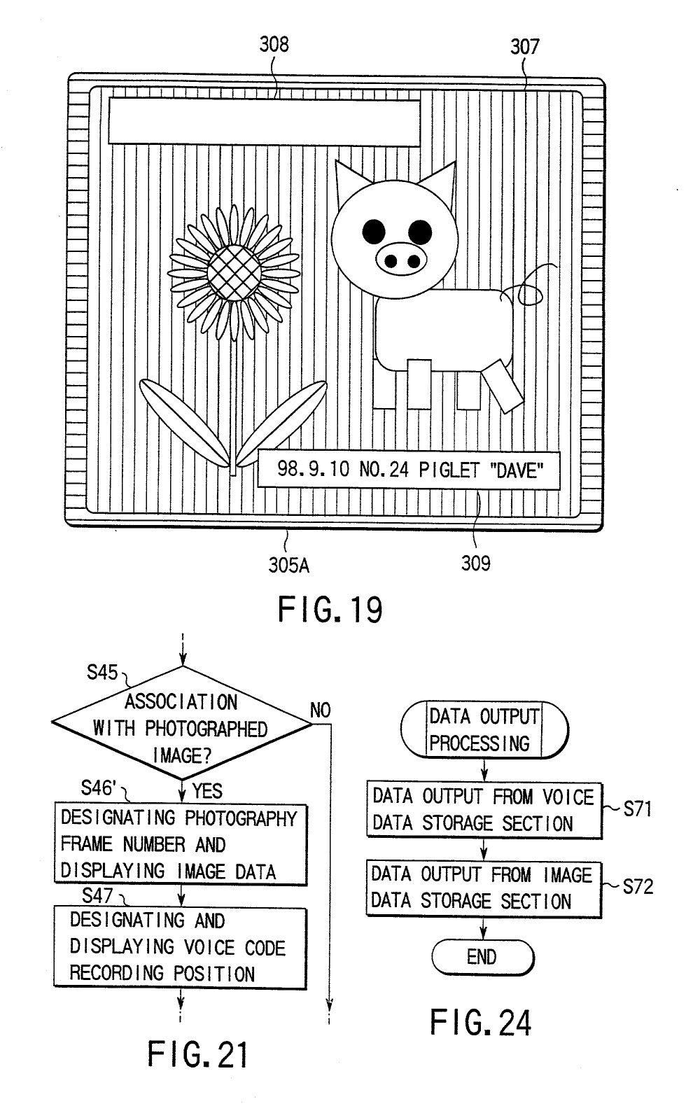

FIG. 19 is an external view showing a liquid crystal view finder 305A as the recording position/image photography information display section 305.

This liquid crystal view finder 305A is composed of a color liquid crystal or the like. This finder is directed to an image display section 307 for entirely displaying an object image, wherein a voice code image recording position 308 and a relating data recording position 309 are displayed. In this case, the voice code image recording position 308 is displayed to be whitened. The frame of relating data recording position 309 is formed with a predetermined color, wherein relating data and information associated therewith are displayed.

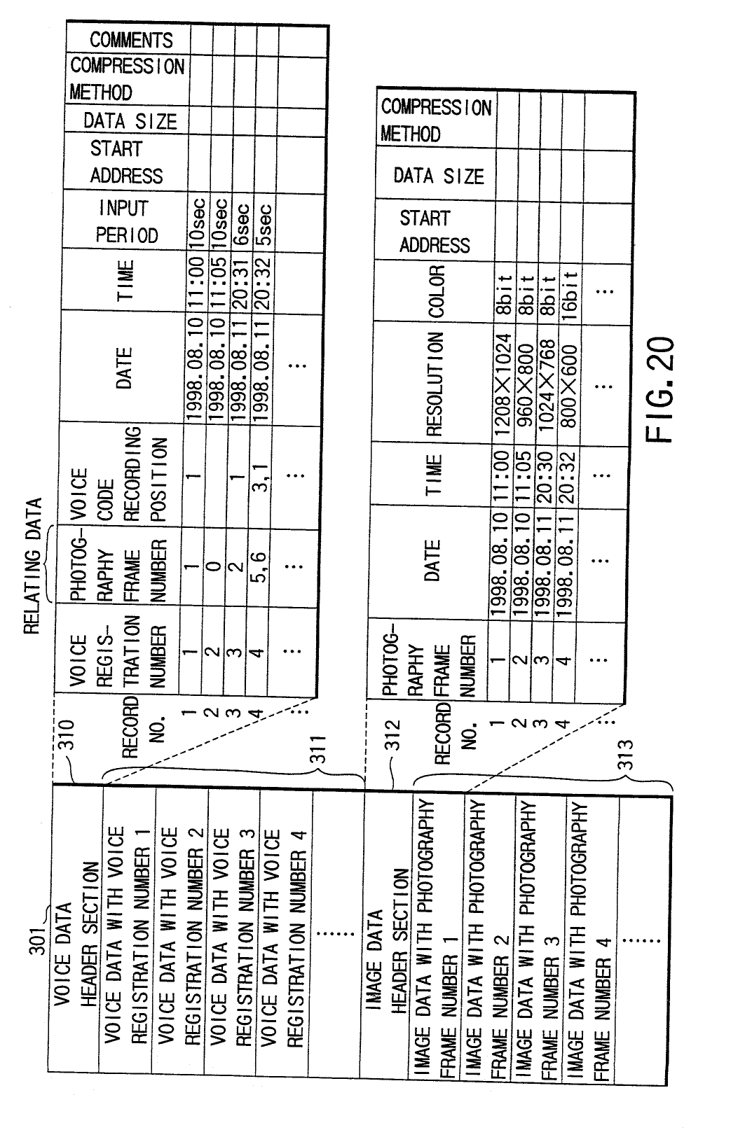

FIG. 20 shows a storage format used in the image data memory 301. The image data memory 301 mainly comprises a voice data header section 310, a voice data storage section 311, an image data header section 312 and an image data storage section 313. The voice data header section 310 and the voice data storage section 311 are similar to the voice data header section 137 and the voice data storage section 138 of the voice data memory 105 shown in FIG. 10, respectively.

The image data header section 312 stores, as one record for each image data item, a photography frame number, a date, a time, a resolution, a color, a start address, a data size, a compression method, etc. The photography frame number relates image data to voice data.

Now an operation of an electronic still camera 300 with such construction according to this second embodiment will be described here.

A main flowchart of this electronic still camera 300 is similar to that of a silver film camera in the first embodiment shown in FIG. 11. In addition, recording start processing, operation mode setting processing, and voice code recording position setting processing in the main flowchart are also similar to those shown in FIGS. 15, 12 and 13. Therefore, only relating data setting processing, photography start processing, and data output processing which are different from those in the first embodiment will be described below.

First, in the relating data setting processing, as shown in FIG. 21, processing in the step S46 is replaced with step S46′ described below, and the other steps are similar to those in the first embodiment shown in FIG. 14. That is, in step S46′, when voice data is allocated to a photographed image, a photography frame number as relating data is designated by an operation of an image selection button 130, and the designated photography frame number and the photographed image data are displayed on the liquid crystal view finder 305A.

The photography start processing includes two cases, i.e., a case in which relating data is generated before photography and a case in which relating data is generated after photography.

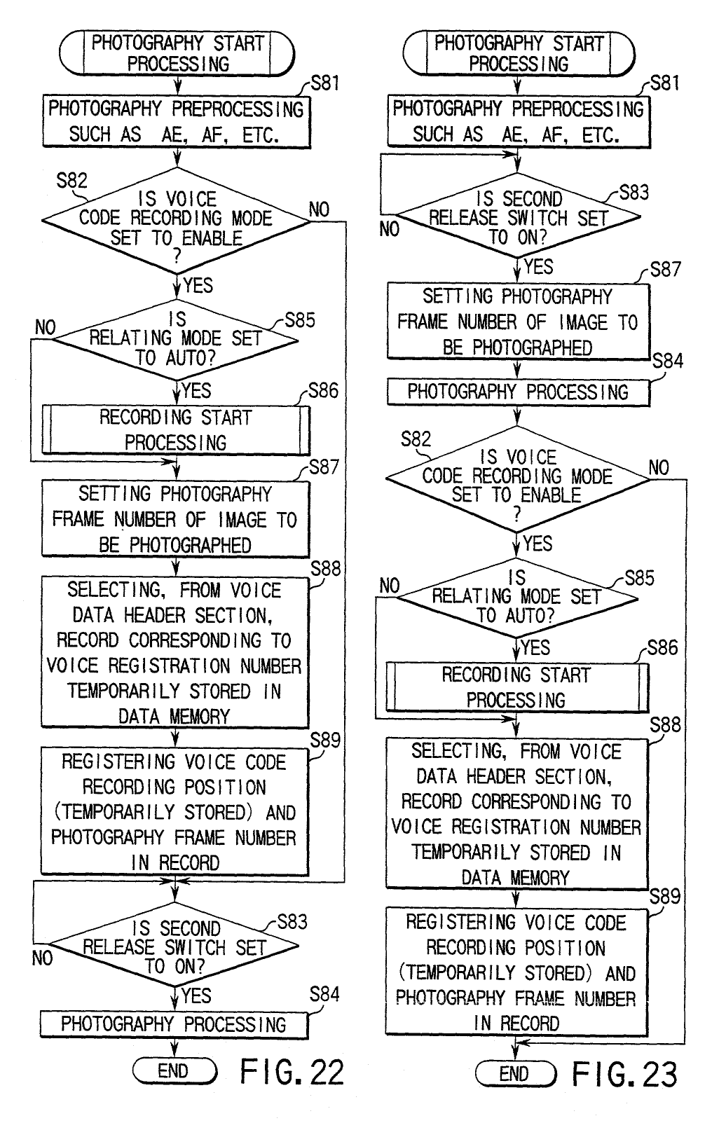

FIG. 22 is a flowchart when relating data is generated before photography. That is, photography preprocessing such as known AE and AF is first executed (step S81), and then, it is determined whether or not voice code recording mode set in the above operation mode setting processing is set to “Enable” (step S82). When the voice code recording mode is set to “Disable”, the second release SW of the photography start button 127 is ready to be turned ON (step S83). When the switch is turned ON, the known photography processing is performed (step S84), and processing returns to the main routine.

On the other hand, when it is determined that the voice code recording mode is set to “Enable”, it is further determined whether or not the relating mode set in the above operation mode setting processing is set to “Auto” (step S85). When the relating mode is set to “Auto”, recording start processing is executed (step S86). In contract, when it is set to “Manual”, processing in the step S86 is skipped.

Then, a photography frame number of an image to be photographed is set (step S87), and the record of the voice data header section 310 of the image data memory 301 is selected from among voice registration numbers temporarily stored in the data memory 109 (step S88). Similarly, the voice code recording position temporarily stored in the data memory 109 and the above set photography frame number are registered in that selected record (step S89). Thereafter, processing proceeds to the step S83, and, in response to ON setting of the second release SW of the photography start button 127, the known photography processing is performed in the step S84. The user can set the photography frame number to be set in the step S87 arbitrarily as is known in the electronic still camera.

On the other hand, FIG. 23 is flowchart when relating data is generated after photography. That is, photography preprocessing such as known AE and AF is first executed (step S81), and the second release SW of the photography start button 127 is ready to be turned ON (step S83). When the switch is turned ON, the photography frame number of an image to be photographed by the frame number generating section 306 is generated and set (step S87), and the known photography processing is performed (step S84). Then, it is determined whether or not the voice code recording mode set in the operation mode setting processing is set to “Enable” (step S82). When the voice code recording mode is set to “Disable”, processing returns to the main routine.

In contrast, when it is determined that the voice code recording mode is set to “Enable”, it is further determined whether or not the relating mode set in operation mode setting processing is set to “Auto” (step S85). When the relating mode is set to “Auto”, recording start processing is executed (step S86). When it is “Manual”, processing in the step S86 is skipped. Then, the record of the voice data header section 310 of the image data memory 301 is selected from among the voice registration numbers temporarily stored in the data memory 109 (step S88). Similarly, the voice code recording position temporarily stored in the data memory 109 and the above designated photography frame number are registered in that selected record (step S89), and processing returns to the main routine.

In addition, in data output processing, as shown in FIG. 24, as in the first embodiment, the data of the voice data storage section 311 of the image data memory 301 is first output from the data output terminal 122 (step S71). Then, in this second embodiment, the data of the image data storage section 313 of the image data memory 301 is further output from the data output terminal 122 (step S72), and processing returns to the main routine.

In the silver film camera described in the first embodiment or in the electronic still camera described in the second embodiment, a construction described below can be adopted as recording position setting means for setting a recording position of a voice code image on a printing medium described in each of these embodiments.

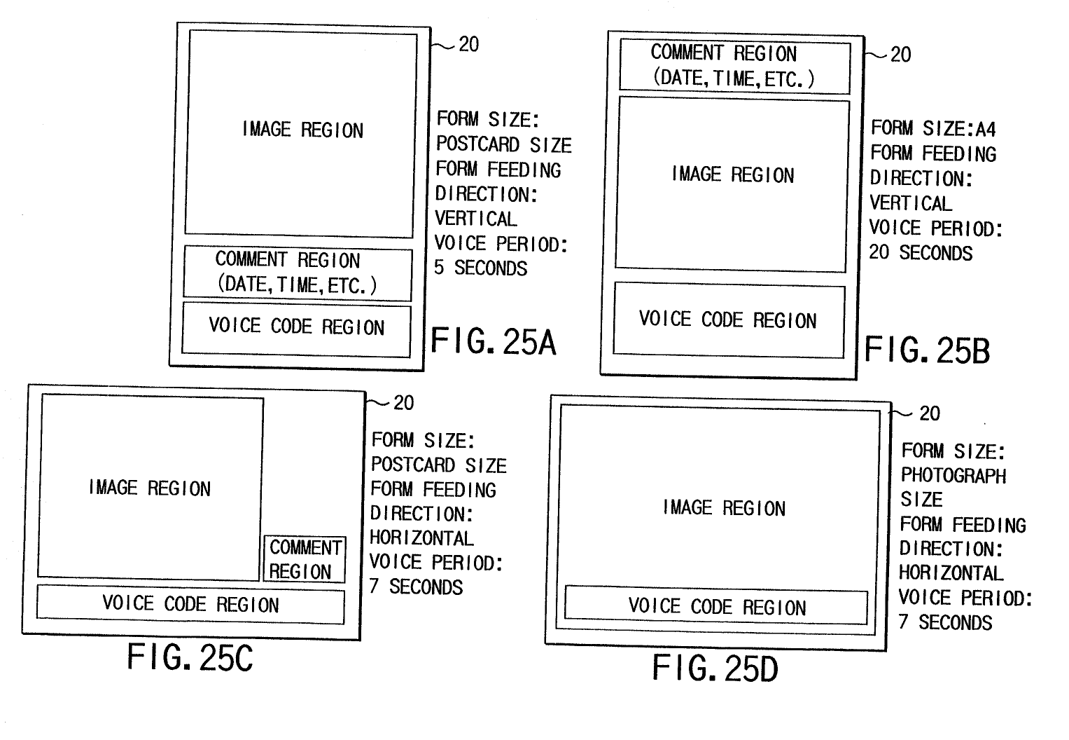

That is, in a program memory 108 in FIG. 5 or FIG. 18, for example, as shown in FIG. 25A to FIG. 25D, information concerning various templates for designating the layout on a printing medium 20 of each region for the photography still image 19, the voice code image 18 and the relating data recording section 22 such as comment is stored in advance. The information concerning these templates is read from the program memory 108, and is displayed on the information display liquid crystal panel 121A. When the user has selected a desired template from among these templates by way of the recording position setting button 120A, the identification information of that selected template is stored as information concerning the voice code image recording position in the voice data memory 108.

In this manner, the user can easily select and determine the photography still image, voice code image and the layout of each region for relating data containing comment or the like on the printing medium, from among various layouts on the camera side.

Of course, in the above program memory 108, the information concerning the above templates may be stored by each device type of printer for recording a photography still image and a voice code image on the printing medium 20 or by each printing resolution thereof.

[An Embodiment of Printer]

Now, a printer for recording a still image photographed by the electronic still camera and a voice code image based on the voice data associated with the still image on the same printing medium will be described by way of an embodiment. The printer according to the present embodiment is not only connected to an external control device 401 as is the case with an external printer 402 shown in FIG. 18, but also is connected directly to an electronic still camera or a memory card.

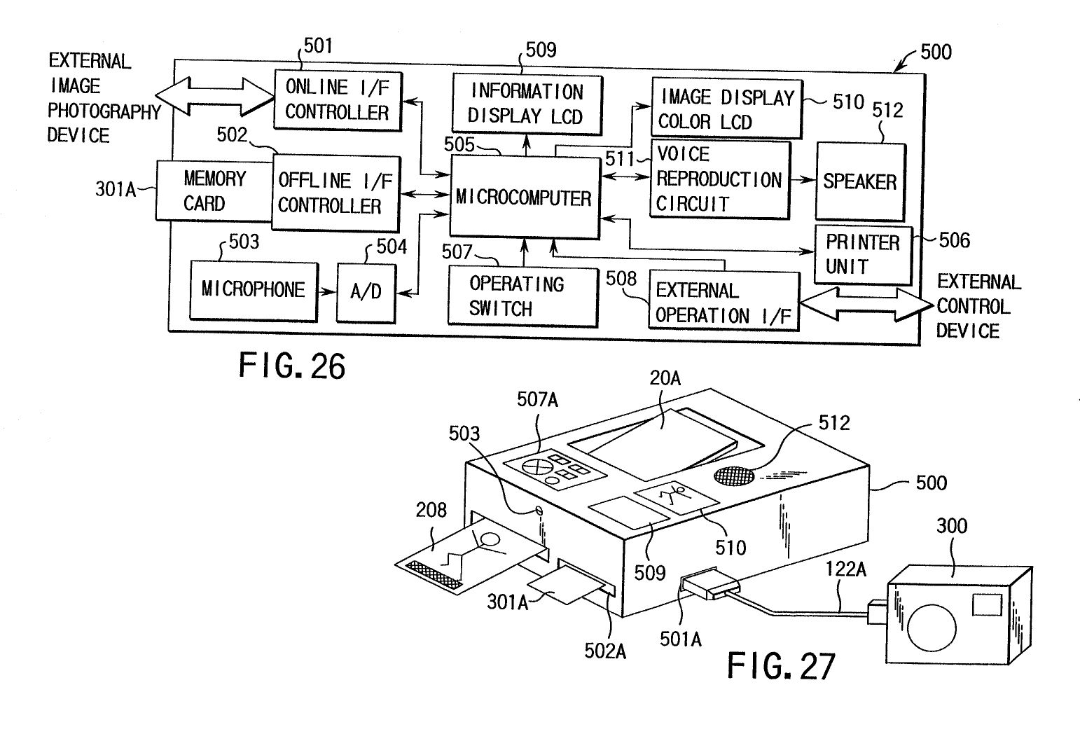

FIG. 26 is a block diagram depicting a configuration of the printer, and FIG. 27 is a perspective view showing an appearance of the printer.

That is, this printer 500 is substantially composed of an online I/F controller 501; an offline I/F controller 502; a microphone 503; an A/D conversion section 504; a microcomputer 505; a printer unit 506; an operating switch 507; an external operation I/F 508; an information display LCD 509; an image display color LCD 510; a voice reproduction circuit 511; and a speaker 512.

The online I/F controller 501 inputs image data corresponding to a still image photographed by the electronic still camera 300 as shown in FIG. 18 and voice data associated therewith or the like in online via the connection cable 122A or public line connected to an online connection I/F connector 501A, and supplies these data items to the microcomputer 505. Similarly, the offline I/F controller 502 mounts media such as memory card 301A storing image data corresponding to a still image photographed by the electronic still camera 300 and voice data associated therewith or the like, inputs the data in offline, and supplies these data items to the microcomputer 505.

The microphone 503 and the A/D conversion section 504 are for inputting voice to this printer 500. The voice data input by the microphone 503 and converted by the A/D conversion section 504 is supplied to the microcomputer 505.

The microcomputer 505 temporarily stores in an internal memory (not shown) of the microcomputer 505 the image data and voice data and the like supplied from the A/D conversion section via the online I/F controller 501, the offline I/F controller 502 or the microphone 503; performs predetermined processing; outputs the data to the printer unit 506, the voice reproduction circuit 511 or the image display color LCD 510 in its predetermined format; and entirely governs a control of sequences or the like of this printer 500.

Specifically, when image data is input to the microcomputer 505, the image data is converted to image data of such type suitable to printer recording, and is output to the printer unit 506. Alternatively, the image data is converted to image data of such type suitable to color LCD display, and is output to the image display color LCD 510.

Further, when voice data is input, the voice data is encoded to generate voice code image data, and is output to the printer unit 506. Alternatively, the voice data is output to the voice reproduction circuit 511, and is externally output via the speaker 512.

The above voice data encode processing is described in detail in U.S. Pat. No. 5,896,403 or the like, and thus a description of this processing will be omitted.

Although it is not shown in particular, the microcomputer 505 incorporates a ROM. This ROM stores predetermined plural types of voice data in advance to be selectable. The voice to be recorded together with a still image on the same printing medium can be generated even in this printer via the above online I/F controller 501 or offline I/F controller 502 without externally inputting it.

The printer unit 506 is a section that inputs image data and voice code image data processed by this microcomputer 505, and prints it as a corresponding still image and a voice code image to a printing medium 20 such as paper. Specifically, this printer unit is composed of a thermal printer or an ink jet printer or the like. In the present embodiment, as shown in FIG. 27, unrecorded printing media 20A stacked on the upper surface of the printer 500 are loaded one by one, still image and voice code image are recorded therein, and a recorded printing medium 20B is fed from a side face.

The image display color LCD 510 inputs image data output from the microcomputer 505, and visualizes and displays a still image corresponding thereto. In addition, the LCD 510 functions as a monitor for checking the recording position of the still image and voice code image as described later, on the printing medium.

The voice reproduction circuit 511 inputs voice data output from the microcomputer 505, and externally outputs the data via the speaker 512. This circuit is used to reproduce and check the voice input from the microphone 513 or voice based on the voice data input from the online I/F controller 501 or offline I/F controller 502, and further, the voice stored in the above ROM.

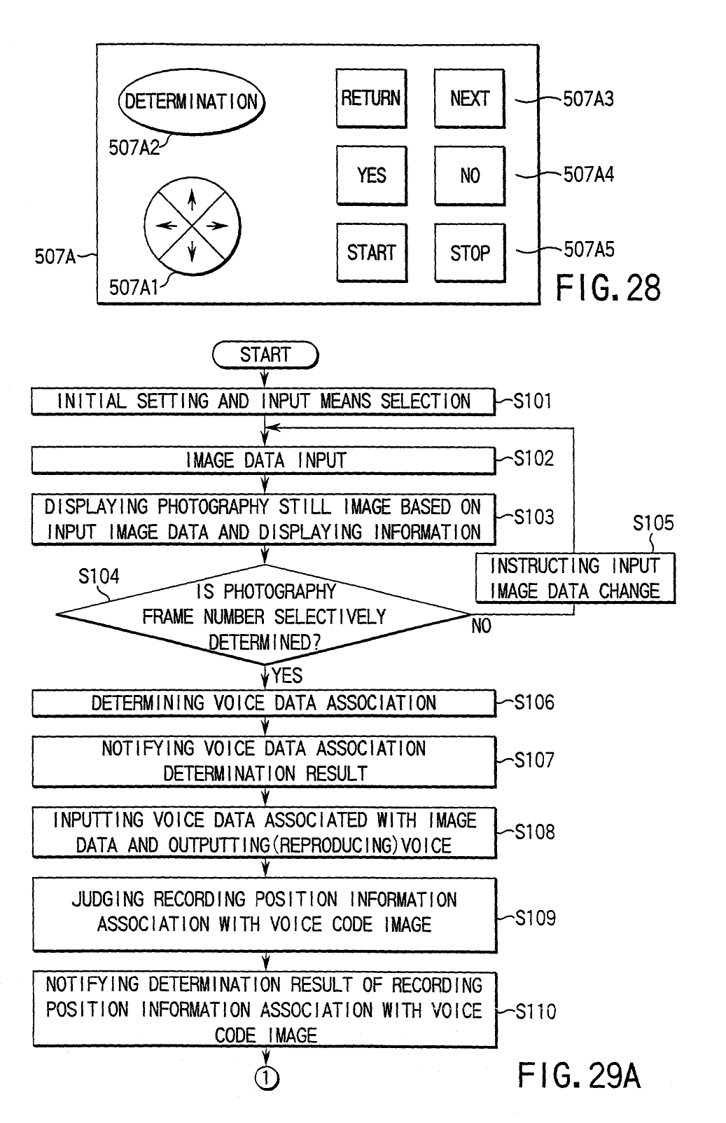

The operating switch 507 can input variable instructions for selecting a frame number of a still image to be recorded by this printer 500; editing the still image or voice; setting (layout setting) of the recording position of the still image or voice code image on the printing medium; instructing a selection of whether or not to record a voice code image; and further, instructing start of recording the still image or voice code image. These input instructions are supplied to the microcomputer 505. Such operating switch 507 includes a plurality of switches for executing each of these input instructions. As shown in FIG. 27, these switches are integrated in one operating switch panel 507A, and are arranged on the upper surface of the printer. That is, on this operating panel switch 507A, as shown in FIG. 28, there are arranged a four-directional cursor position moving switch 507A1 for moving a position of a cursor displayed on the image display color LCD 510; a selected-content determining switch 507A2 for instructing determination of the selected content; a processing step moving switch 507A3 including two buttons, i.e., “Return” and “Next”; a selection instructing switch 507A4 including two buttons, i.e., “Yes” and “No”; and a processing control switch 507A5 including two buttons, i.e., “Start” and “Stop”.

The external operation I/F 508 is constructed so that various control signals or data supplied to this printer can be input via an external personal computer or a public line, and these signals or data are output to the microcomputer 505.

The information display LCD 509 displays an operation setting state for this printer 500 or performs various broadcastings or warning and the like. Specifically, this LCD displays a statue inclusive of whether or not voice data is associated with input image data, or whether or not the recording position information which designates the recording position between the still image on the printing medium and the voice code image thereon is associated with the input image data.

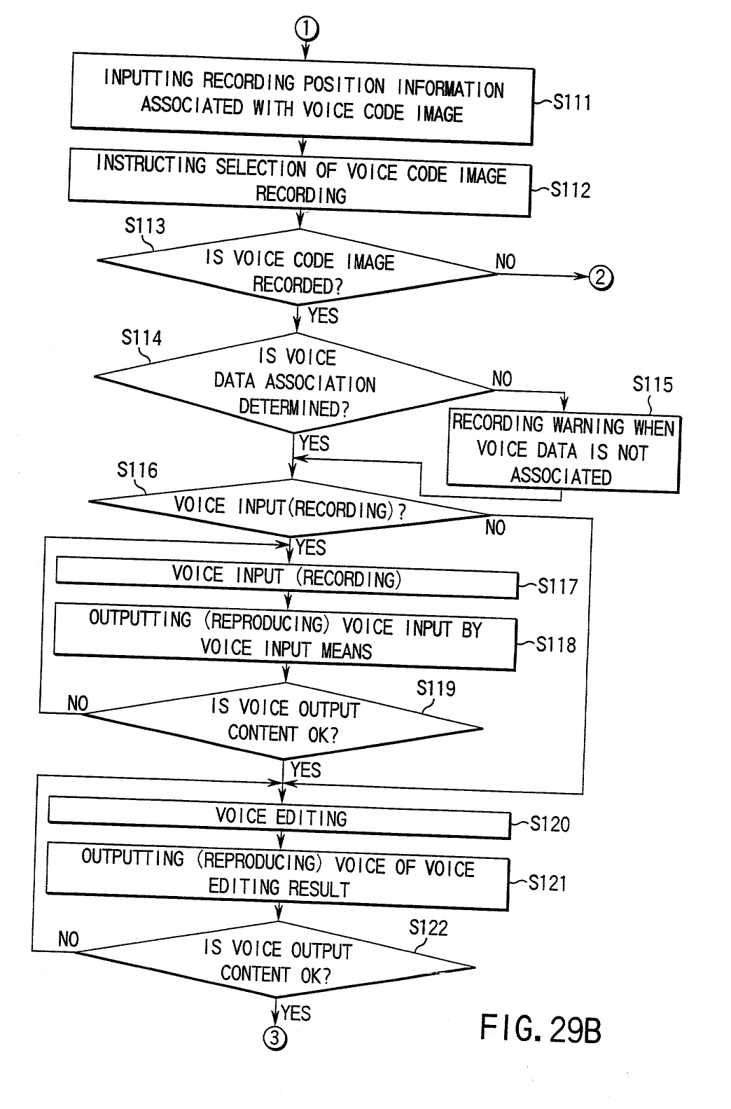

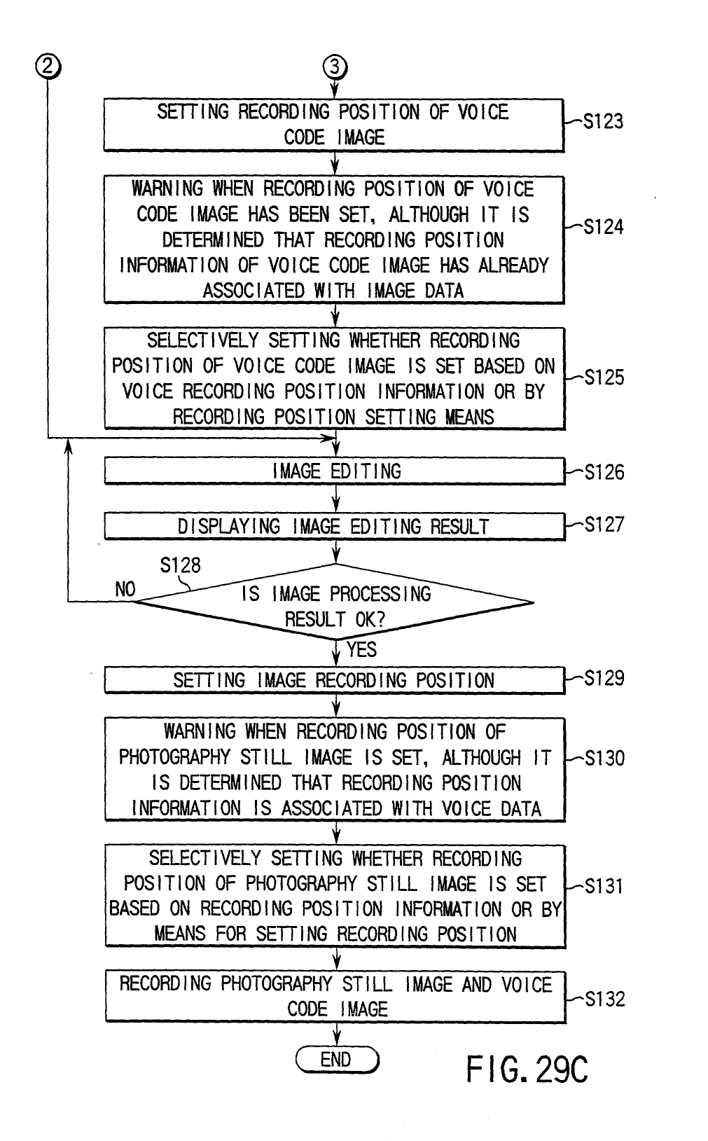

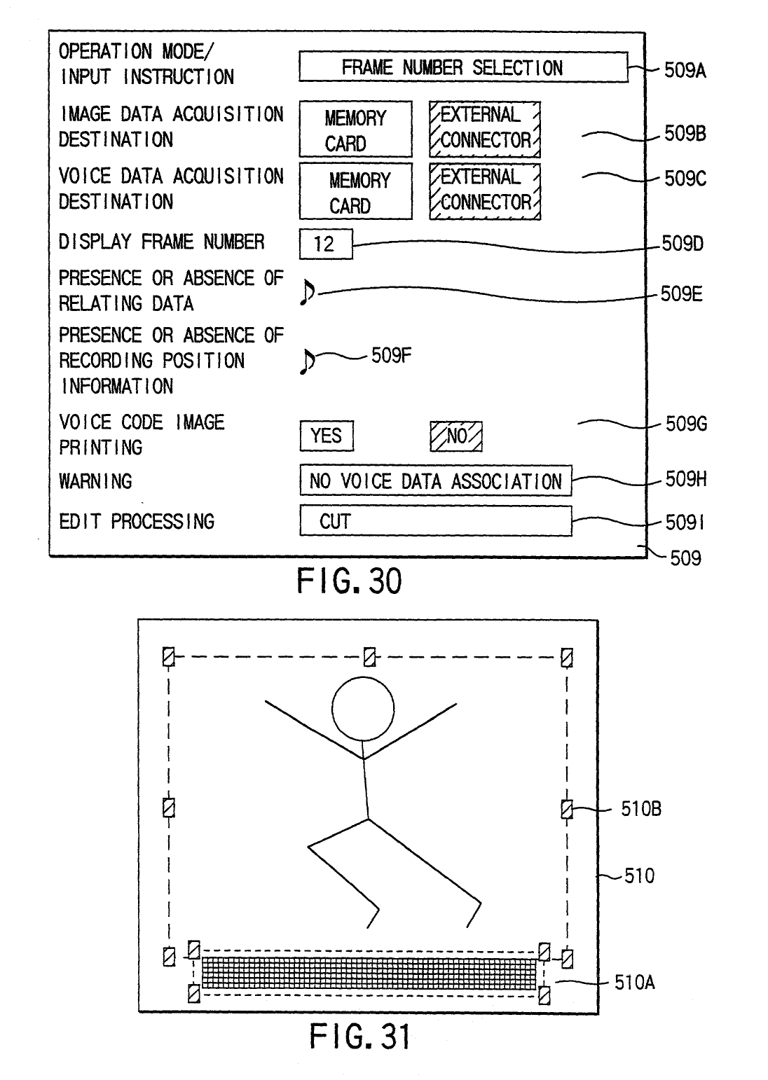

Hereinafter, an operation of the printer shown in FIG. 26 and FIG. 27 will be described in accordance with a series of flowcharts shown in FIG. 29A to FIG. 29C.

After power has been supplied, the microcomputer 505 first initializes each section of the printer 500, and checks source data input means (step S101). That is, the microcomputer 505 checks the input means by performing a connection response check as to which of the external devices connected online and offline stores image and relating data as a storage destination, and the source data input means is selected. When the printer includes manual setting means, the input means may be selected according to the user intention other than determination of the microcomputer 505.

The device connected online denotes a device including data transfer control functions such as digital camera, computer or the like. The device connected offline denotes a storage medium that does not include any data transfer control function such as card type memory therein.

Next, the microcomputer 505 reads image data stored by the selected input means, and inputs the data to a memory incorporated in the microcomputer 505 (step S102).

The microcomputer 505 converts the input image data into displayable image data; displays an image for the user to select a still image to be recorded on the printing medium 20 on the image display color LCD 510; and displays information on the information display LCD 509 (step S103).

At this time, the information display LCD 509 displays a “Frame number selection” in a field 509A for “operation mode/input instruction”. The display of the field 509A for “operation mode/input instruction” can be changed by each operation mode. In addition to the “Frame number selection”, the display includes “voice code image printer selection”, “Record”, “Voice edit”, “Voice code image printing position setting”, “Image edit”, “Image recording position setting”, “Print”, “OK?” or the like.

In addition, the information display LCD 509 includes a “memory card/external connector” display 509B for displaying input means determined in step S101. That is, when a destination of acquiring image data is offline, the “memory card” is displayed to be discriminated. When it is online, the “external connector” is displayed to be discriminated. Further, a display frame field 509D displays a frame number of an image displayed on the above image display color LCD 510.

Then, the user make a selection of the frame number of a photography still image to be recorded, by means of the operating switch 507 (step S104). That is, the microcomputer 505 reads image data of the selected frame number, and displays the data on the image display color LCD 510. The user finally determines the frame number of the photography still image to be recorded on the printing medium 20, by means of the operating switch 507, while checking the photography still image. The image selection screen may be displayed on the image display color LCD 510 by one or more frames. In the present embodiment, image data is input and displayed by each frame. If a photography still image displayed on the image selection screen is not a desired image to be recorded on the printing medium, the user operates a cursor position moving switch 107A1 to make the display frame number field 509D active. Then, the user operates the “Next” button of the processing step moving switch 507A3. The microcomputer 505 instructs the input means to change input image data in order to input image data. Namely, the microcomputer designates input of the next frame number (step S105). Then, processing returns to image data input of the step S102.

The output designation of the frame number is determined depending on input means. In the case of online connection, this is accomplished by incrementing the parameters contained in communication protocols. In the case of offline connection such as memory card, this is accomplished by changing an address to be accessed by referring to directory information.

In addition, when a plurality of frames are displayed, and a desired frame is selected from among them, a jump from the step S104 to the step S102 via the step S105 is performed in units of plural frames to be displayed.

When the microcomputer 505 incorporates a memory having its capacity larger than the image data capacity of the input means, all image data may be read in batch from the input means. In that case, a jump from the step S105 to S103 may be performed.

If a desired image is displayed on the image display color LCD 510, the user operates a selected-content determining switch 507A2. In this manner, in the step S104, it is determined that the frame number of a photography image to be recorded on the printing medium has been determined. In this case, in order to investigate whether or not voice data is associated with image data of that frame, determination of voice data association is performed (step S106). The voice data association information to source image data is stored in the header information of the voice data, and thus, such determination is made by referring to the header information thereof.

Next, processing goes to step of notifying the result of the voice data association determination (step S107). That is, when it is determined that the voice data is associated in the step S106, a voice data association mark 509E is displayed on the information display LCD 509. When it is determined that the voice data is not associated, this voice data association mark is not displayed, thereby notifying the user of the voice data association determination result.

Then, when it is determined that the voice data is associated with image data in the step S106, the voice data is input (step S108). At this time, a destination of acquiring the voice data is notified by the “memory card/external connector” display 509C. The input voice data is read to the voice reproduction circuit 511, and reproduced as an audible voice by the speaker 512 through D/A conversion processing and amplification processing.

The voice data storage destination may be the same as or may be different from the image data storage destination. For example, image data may be stored in an online connected external device, and voice data to be associated therewith may be stored in an offline connected card type memory or one of predetermined plural types of voice data items to be stored in a ROM that the microcomputer 505 of the apparatus incorporates may be designated.

Next, it is determined whether or not the recording position information on a voice code image is associated by referring to the header information on voice data (step S109). When it is determined that the recording position information on a voice code image is associated, the recording position information association mark 509F for the voice code image on the information display LCD 509 is displayed. In contrast, when it is determined that the recording position information is not associated, the recording position information association mark 509F for the voice code image on the information display LCD 509 is not displayed, thereby notifying the user of the determination result of recording position information association (step S110).

When it is determined that the recording position information on the voice code image is associated, the recording position information is input by referring to the header information of voice data (step S111). When it is determined that the recording position information on the voice code image is not associated, the step S111 is directed to through processing.

In addition, in order to notify the user of a recording position of the voice code image, the microcomputer 505 may display a recording position display mark on the image display color LCD 510.

The processings in steps S101 to S111 are directed to a stage for the user to check the information concerning the externally stored image data or voice data.

Then, when voice data is associated with the photography still image, a voice code image recording selection instruction is performed as to whether or not to record the voice code image on a printing medium, and when the voice data is not associated, the same selection instruction is performed as to whether or not to record newly generated voice data on the printing medium (step S112). The above newly generated voice data denotes a record from the microphone 503 or designation of predetermined voice data stored in the ROM inside of the microcomputer 505.

The user instructs and inputs a voice code image recording selection as to whether or not to record a voice code image by means of an operating switch 507. That is, the user operates a cursor position moving switch 507A1, thereby selecting a “Yes/No” 509G of “voice code image print”.

The microcomputer 505 determines an instruction of input for this voice code image recording selection (step S113). When it is determined that a voice code image is recorded, processing goes to branch processing in accordance with the determination result of voice data association in step S114. In addition, when it is determined that a voice code image is not recorded, there is no need for performing processing associated with voice data. Thus, processing concerning recording targeted for the selected photography still image may be performed. Then, processing jumps to step of image edit in step S126 described later.

That is, when a voice code image is recorded, branch processing in accordance with the determination result of voice data association is performed (Step S114). When it is determined that voice data is not associated with the already selected image data, a warning on recording is performed for a warning display field 509H of an information display LCD 509 in order to warn the user that the source voice data of the voice code image to be recorded does not exist yet (step S115). Then, processing goes to processing for selecting whether or not the user performs voice input (recording) in step S116. In this warning display field 509H, in addition to this warning on recording, a variety of warnings indicative of the absence of voice data association, voice code image recording position change, and image recording position change are displayed in changeable manner. These warnings are preferably displayed so as to strongly focus the user's attention such as blinking.

Conversely, when it is determined that the voice data is associated in the step S114, the source voice data of the voice code image to be recorded already exists. Thus, processing goes to processing for selecting whether or not the user performs voice input (recording) in step 116 without performing the warning on recording. Although the thus associated voice data exists, the user is forced to select whether or not to perform voice input (recording). This is not because the voice data is recorded as is, but enables edit operation such as dubbing, even if the already associated voice data exists.

It is selected as to whether or not to perform the user voice input (recording) (step S116). When voice input is selected, processing goes to voice input (record) processing in step S117. When voice input is not selected, the processing for checking the recording result from voice input (steps S117 to S119) is jumped, and processing goes to voice edit processing (step S120).

That is, when voice input (recording) is performed, the voice signal from the user speaking microphone 503 is converted into voice data by means of the A/D conversion section 504, and is stored in a memory inside of the microcomputer 505 (step S117).

Next, the voice input by the voice input means is output (reproduced), thereby enabling the user to listen to the record content (step S118). The voice input means include the online I/F controller 501 and the offline I/F controller 502 as well as the above microphone 503 and A/D conversion section 504.

The user determines whether or not the record content enters a desired state by listening to this voice output (step S119). To retry recording, processing returns to voice input (record) processing in the step S117.

In contrast, when the record content is acceptable, the user selects and executes desired processing for voice edit by the operating switch 507, whereby the voice edit processing is performed (step S120). The voice edit processing includes selecting associated voice data or voice input (recorded) voice data to isolate, copy, or paste part or all of these voice data items by designating a period; and special processing such as equalizer processing for changing frequency characteristics or echoing. The microcomputer 505 performs the above selected voice edit processing for the voice data stored in the internal memory, and stores the result in the internal memory.

Voice edit processing is performed by the user by selecting desired processing from a menu 509I of voice edit processing displayed on the information display LCD 509 by the operating switch 507. The display content of this edit processing menu 509I is displayed by changing it during voice editing or image editing.

If parameter input is required for processing by designating a position (period) during voice edit operation, such parameter input is performed by the operating switch 507. In addition, voice data may be used as is without performing voice edit processing other than voice data selection.

After voice edit processing has been thus executed, in order for the user to check the edited voice data, the microcomputer 505 reads the edited voice data from the internal memory; converts the data into a voice signal via the voice reproduction circuit 511; and reproduces it by means of the speaker 512 (step S121).

The user determines whether or not the content is a desired voice edit processing result by listening to this reproduction output sound, and performs inputs by the operating switch 507 according to the processing result.

If the reproduction output content is undesirable, a NO selection instructing switch 507A4 is operated (alternatively, the “Return” processing step moving switch 507A3 may be employed). In this case, processing returns to the step S120 to retry voice edit processing. In contrast, if the reproduction output content is desirable, the “YES” selection instructing switch 507A4 is operated (alternatively, the selection content determining switch 507A2 may be employed). In this case, a series of processings associated with voice edit is terminated, and processing goes to the next step.

That is, when the reproduction output content is desirable, a voice code image recording position is set (step S123). In this step, the microcomputer 505 displays a region cursor 510A for setting the recording position of the voice code image on the image display color LCD 510, as shown in FIG. 31. In the case where it is determined that recording position information on the voice code image is associated in the step S109, it is determined that the recording position information on the voice code image is associated, this recording position is directed to a position based on the position information. In addition, when it is determined that the recording position information on the voice code image is not associated, the region cursor 510A for setting the recording position of the voice code image is displayed at a default position at the lower stage of the image display region. The user operates the cursor position moving switch 507A1 to move this region cursor 510A vertically or horizontally; and sets a position of recording the voice code image at a desired position on the image display region.

Although it is determined that the recording position information on the voice code image is associated, in the case where the user thus moves the region cursor 510A for setting a recording position of a voice code image, thereby setting the recording position of the voice code image, the microcomputer 505 displays a warning indicative of voice code recording position change in the warning display field 509H of the information display LCD 509, and warns the user that a change operation is performed (step S124).

After an operation for setting the recording position of the above voice code image, in the case where it is determined that the recording position information on the voice code image is associated, the microcomputer 505 selects the recording position information on the already associated voice code image to the image data or display a prompt for input of whether or not to select the recording position information changed later, on the information display LCD 509. Then, the user sets and inputs the selection by the operating switch 507A (step S125).

A series of processings concerning voice data and its recording position are assumed to have been executed by the processings in the steps S112 to S125. Next, a series of processings concerning image data is performed.

That is, first, the user selects desired processing from the image edit processing menu displayed on the information display LCD 509 by the operating switch 507, whereby image edit processing is performed (step S126). During this image edit operation, when parameter input is required for processing by position designation or the like, such parameter input is performed by the operating switch 507. The image editing includes, for example, trimming processing for only part of an image; expansion or reduction size change; color table change processing such as solarization or posterization employed for a special effect; or processing for changing color gradation characteristics to adjusting brightness or tone and the like.

The thus image edited result is displayed to be visualized by the image display color LCD 510 (step S127).

The user instructs and inputs a selection of whether or not the image edit result is acceptable, namely, whether or not image edit is terminated (step S128). If the image edit result is not OK, the microcomputer 505 returns to image edit processing in the step S126. When it is OK, the microcomputer 505 proceeds to processing for selecting and inputting an image recording position in the next step S129.

That is, the microcomputer 505 displays a region cursor 510B for setting an image recording position on the image display color LCD 510 (step S129). In the present embodiment, although the region cursor 510B represents the positions of four corners of the outer frame of the photography still image displayed on the display screen of the image color LCD 510 and each of the neutral point of four line segments constituting the outer frame, only the positions at the four corners of the outer frame may suffice.

When it is determined that the recording position information on the voice code image is associated in the step S109, the recording position is directed to a position based on the information. In addition, when it is determined that the recording position information is not associated, the region cursor 510B for setting the image recording position is displayed at a default position justified to the upper left corner of the image display region. The user moves this region cursor 510B vertically and horizontally, thereby setting a position of recording an image at a desired position on the image display region.

Although it is determined that the recording position information is associated, in the case where the user moves the region cursor 510B for setting an image recording position, thereby setting the image recording position, the microcomputer 505 displays a warning indicative of image recording position change in the warning display field 509H of the information display LCD 509, and warns the user that a change operation is performed (step S130).

After image recording position setting operation, when it is determined that the recording position information is associated, the microcomputer 505 display a prompt for input of whether to select the already associated recording position information or select the recording position information changed later on the information LCD 509. Then, the user sets and inputs the selection by the operating switch 507 (step S131)

Lastly, a photography still image and a voice code image are recorded (step S132). In this recording step, the microcomputer 505 converts the input and generated image data and/or voice code image in the foregoing steps (S101 to S131) to data suitable to be printed by the printer unit 506 in accordance with the recording position information or settings. Then, the microcomputer 505 records the data on the printing medium 20 while head feeding and paper feeding control of the printer unit 506 are performed.

Although the present invention has been described based on the foregoing embodiments, the present invention is not limited to the aforementioned embodiment, and various modifications or applications can be performed within the scope of the spirit of the present invention. The spirit of the present invention is as follows:

(1) A photography device for use in a photography image processing system capable of recording an optically readable voice code image on a printing medium having a photography still image recorded thereon, comprising:

a voice input section for inputting a voice corresponding to the voice code image;

a digital conversion section for converting an input voice in the voice input section to digital voice data;

a voice data memory for storing the converted digital voice data by the digital conversion section; and

a relating data generating section for generating relating data for associating a photography still image and a voice code image recorded on the same printing medium,

wherein the voice data memory inputs the relating data generated by the relating data generating section, associates the input relating data with the associated voice data, and stores the relating data.

That is, the voice data memory is constructed so as to input relating data for the photography still image and voice code image recorded on the same printing medium, associate the input data with the associated voice data, and stores the data.

Therefore, there is achieved an effect of solving the problems of the present invention, namely, an effect that a photographed still image, and a voice code image recorded on the same printing medium as that having the still image recorded thereon can be associated reliably and simply under an actual photography circumstance.

(2) The photography device according to (1), further comprising a voice compression section for compressing the converted digital voice data by the digital conversion section,

wherein the voice data memory stores the compressed voice data by the voice compression section.

That is, the voice data memory stores the compressed voice data. Therefore, the voice data memory capacity can be reduced. In addition, a compression section is provided on a camera side, thus making it possible to change a compression method for each camera.

(3) The photography device according to (1) or (2), wherein

the photography device is a film camera for use in a photography image processing system capable of recording a photography still image exposed on a film by baking the image to a printing paper that is the printing medium and recording the voice code image on the same printing paper, and

the film camera further comprises a data output terminal for externally outputting voice data and relating data associated with the voice data stored in the voice data memory.

That is, when the photography device is a film camera, media stored the photographic still image information and the voice information physically (a film and a voice data memory) differs from each other. During information transmission to a photography laboratory system (a photography image processing system capable of recording an image by baking it to a printing paper that is a printing medium, and recording the voice code image on the same printing paper), a problem that association with the photography still image and the voice code image cannot be maintained is likely to occur. However, the photography device further comprises a data output terminal for externally outputting the voice data stored in the voice data memory and the stored relating data associated therewith. Thus, even if a voice data memory is structurally incapable of being detachable from the camera main body, the relating data can be transmitted from the data output terminal to the photography laboratory system via a cable or a telephone line. Therefore, there is provided an effect that a printing medium having the still image recorded thereon and a voice code image recorded on the same printing medium can be associated reliably and simply.

(4) The photography device according to (1) or (2), wherein

the photography device is a film camera for use in a photography image processing system capable of recording a photography still image exposed on a film by baking the image to a printing paper that is the printing medium, and recording the voice code image on the same printing paper, and

the film camera have the voice data memory detachably arranged thereon.

That is, the film camera has the voice data memory detachably arranged thereon, thereby making it unnecessary to provide accessories such as connection cable or telephone line transmission circuit or additional circuits during information transmission to a photography laboratory system. Thus, there is provided an effect that a camera system can be reduced in price, weight, and power consumption; and a photographed still image and a voice code image recorded on the same printing medium as that having the still image recorded thereon can be associated reliably and simply.

(5) The photography device according to (3) or (4), wherein the film camera is constructed so that at least one of the relating data generated by the relating data generating section and information associated therewith is displayed to be recorded at a predetermined portion on the film.

That is, the film camera is constructed so that the relating data generated by the relating data generating section or information associated therewith is displayed to be recorded at a predetermined portion on the film. Thus, in the photography laboratory system, after film development, the data recorded and displayed on the film or information associated therewith is read before recording a voice code image. Then, the read data or information is compared with the relating data transmitted together with the voice data. Thus, there is provided an effect that the photographed still image and the voice code image recorded on the same printing medium as that having the still image recorded thereon can be associated more reliably and simply.

(6) The photography device according to (1) or (2), wherein

the photography device is an electronic still camera for use in a photography image processing system comprising an image memory for outputting a photography still image exposed on a light receiving surface of an image pick-up device as an image signal, and storing image data having the output image signal digitized, the system being capable of recording an image based on the image data stored in the image memory on the printing medium, and recording the voice code image on the same printing medium,

the electronic still camera has the image memory compatible with the voice data memory, and

the image memory stores the image data, voice data, and relating data to be associated with.

The electronic still camera has the image memory compatible with the voice data memory, and the image memory is constructed so as to store the image data, voice data, and relating data to be associated with. Thus, in comparison with a case in which the image memory and voice data memory are constructed independently, a camera system can be reduced in price, weight, and power consumption, and the photography still image information and recording voice information can be stored and managed in the same medium. Thus, there is provided an effect that the still image and voice code image can be associated with each other more reliably and simply.

(7) The photography device according to (6), wherein the electronic still camera further comprises a data output terminal for externally outputting the image data, voice data, and relating data stored in the image memory.

That is, the electronic still camera further comprises a data output terminal for externally outputting the image data, voice data, and relating data stored in the image memory, whereby even if a voice/image data memory is structurally incapable of being detachable from the camera main body, the relating data can be transmitted from the data output terminal to an external printing system (including a digital photography laboratory system) via a cable or a telephone line. Thus, there is provided an effect that the photographic still image and the voice code image recorded on the same printing medium as that having the still image recorded thereon can be associated reliably and simply.

(8) The photography device according to (6), wherein the electronic still camera has the image memory detachably arranged thereon.

That is, the electronic still camera has the image memory detachably arranged thereon, thereby making it unnecessary to provide accessories such as connection cable or telephone line transmission circuit or additional circuit during information transmission to an external printing system (including a digital photography laboratory system). Thus, there is provided an effect that a camera system can be reduced in price, weight, and power consumption, and the photographed still image and the voice code image recorded on the same printing medium as that having the still image recorded thereon can be associated reliably and simply.

(9) The photography device according to (1) or (2), wherein the relating data generating section is constructed so as to be automatically generate the relating data based on predetermined operation before or after photography.

That is, the relating data generating section is constructed so as to automatically generate the relating data based on predetermined operation before or after photography. Thus, there is provided an effect that the user can set association with the photography still image and voice code image more reliably and simply without making any mistake.

(10) The photography device according to (9), wherein the relating data includes a photography frame number of a photographed still image.

That is, the relating data includes the photography frame number of the photographed still image, thus ensuring direct association with the still image. Therefore, there is provided an effect that the relating data can be associated with the still image more reliably and simply.

(11) The photography device according to (1) or (2), wherein the relating data generating section is constructed so as to generate the relating data based on manual input operation before or after photography.

That is, the relating data generating section is constructed so as to generate the relating data based on manual input operation before or after photography. Thus, there is provided an effect that association with the photography still image and the voice code image can be set by the user's intention, and association editing can be performed more flexibly. For example, a single item of recorded-voice data can be selectively associated in common with a plurality of photography still images.

(12) The photography device according to (1) or (2), wherein

the photography device further comprises a recording position setting section for setting a recording position of the voice code image on the printing medium, and

the voice data memory is constructed so as to store information concerning the recording position of the voice code image set by the recording position setting section to be associated with the voice data and the relating data.

That is, when the voice code image is recorded on the photography still image, if there is not determined a position of the recording region in the photography still image in which the voice code image is recorded, a main object or its composition is adversely affected, and a photograph against the photographer's intention is produced. In addition, if a voice code image is recorded on the photography still image unintentionally, there exists an image having various patterns or hues caused by its original image on its base. Thus, the voice code image cannot be read occasionally because the image is obliged to undergo an unexpected change. For example, in the above mentioned dot code format configuration, a marker cannot be extracted, making it impossible to read each of the dots in a data area.

Thus, information concerning the recording position of the voice code image set by the recording position setting means is stored in the voice data memory to be associated with the voice data and the relating data. There is provided an effect that an adverse affection of the photography still image upon a picture is determined by the user's intention, thereby making it possible eliminate or reduce such adverse affection and ensure stable code readability.

(13) The photography device according to (12), wherein the photography device further comprises a display section for displaying a recording position of the voice code image set by the recording position setting section.

That is, the photography device further comprises a display section for displaying a recording position of the voice code image set by the recording position setting section, thus making it possible for the user to easily confirm and determine the recording position during the position setting.

(14) The photography device according to (13), wherein the display section is provided in a photography finder.

That is, the display section is provided in the photography finder, whereby there is provided an effect that the user can determine a composition including a voice code image recording region while seeing the finder in a series of image photographing operations, and can easily set the composition with less movement of line of sight.

(15) A printer for use in a photography image processing system capable of recording an optically readable voice code image on a printing medium having a photography still image recorded thereon, comprising:

an input section for inputting image data corresponding to the photography still image;

a determination section for judging whether or not voice data to be recorded as the voice code image on the same printing medium together with the photography still image based on the image data is associated with image data input by the input section;

an instructing section for instruction a selection of whether or not the voice code image is recorded on the printing medium; and

a control section for, when the determination section determines that the voice data is associated with the image data, and when the instructing section instructs a selection for recording the voice code image on the printing medium, recording the photography still image and the voice code image on the same printing medium.

That is, even if voice data is associated with image data, a photography still image and the corresponding voice code image can be always prevented from being uniquely recorded on the same printing medium. Further, the photography still image and voice code image can be selectively recorded on the same printing medium as required. Therefore, the use can easily obtain a printing medium of preferable type on which the voice code image is recorded, or not recorded. (16) The printer according to (15), further comprising a photography still image selection section for selecting the photography still image recorded on the printing medium.

That is, the user can arbitrarily select and specify a photography still image to be recorded on the printing medium by, for example, frame number, and thus, can obtain a printing medium having a desired photography still image recorded thereon.

(17) The printer according to (15), further comprising a notifying section for, when the determination section determines that the voice data is associated with the image data, notifying the determination result.

That is, the user can grasp reliably that voice data is associated with the input image data, and thus, can supply an instruction for recording the photography still image and voice code image on the same printing medium.

(18) The printer according to (15), further comprising a warning section for, when the determination section determines that the voice data is not associated with the image data, and when the instruction is given to a selection for recording the voice code image on the printing medium, supplying a predetermined warning.

That is, although voice data is not associated with the input image data, when an instruction for such association is supplied so as to record the photography still image and voice code image, the warning section can warn the user that such instruction becomes wasteful. Thus, the user can avoid mistakenly recognizing that the printer fails based on the fact that a voice code image is not recorded on the printing medium, for example.

(19) The printer according to (15), further comprising an image edit section for editing the photography still image corresponding to the image data input by the input section.

That is, the user can edit (change) the input photography still image desirably, thus making it possible to obtain a more sophisticated printing medium.

(20) The printer according to (15), further comprising an image recording position setting section for setting a recording position of the photography still image to be recorded on the printing medium.

That is, the user can set (change) a recording position of a photography still image recorded on the printing medium, thus making it possible to obtain a more sophisticated printing medium.

(21) The printer according to (15), further comprising a voice edit section for editing the voice associated with the image data.

That is, the user can desirably edit (change) the voice associated with the image data, thus making it possible to obtain a more sophisticated printing medium with a voice code image.

(22) The printer according to (15), further comprising a voice recording position setting section for setting a recording position of the voice code image recorded on the printing medium.

That is, the user can set (change) the recording position of the voice code image recorded on the printing medium, making it possible to obtain a more sophisticated printing medium with a voice code image.

(23) The printer according to (15), wherein

the determination section include an association determination section for judging whether or not recording position information is associated with the image data input by the input section other than the voice data, the recording position information defining a recording position of the voice code image on a same printing medium, and

the printer further comprises a notifying section for, when the association determination section determines that the recording position information is associated, notifying the determination result.

That is, the user can further grasp reliably that recording position information that defines the recording position of the voice code image is associated with image data together with voice data. Thus, these photography still image and voice code image can be recorded reliably in according with a layout of these photography still image and voice code image on the printing medium without taking its layout into consideration.

(24) The printer according to (23), further comprising an image recording position setting section for setting a recording position of the photography still image recorded on the printing medium, wherein

the notifying section supply a predetermined warning when the determination section determines that the recording position information is associated with the image data, and when the image recording position setting section sets a recording position of the photography still image.

That is, although recording position information is associated with image data, when the printer supplies an instruction for such association in order to set the recording position of the photography still image, the user can be warned of the fact. Thus, the user can take appropriate action for a method for setting the recording position of these photography still image and voice code image on the printing medium.

(25) The printer according to (24), further comprising a selection section for selecting any one of settings provided by the image recording position setting section and provided based on the recording position information when the recording position of the photography still image is set.

That is, the user can select arbitrarily either of the methods for determining the layout of these photography still image and voice code image based on the recording position information on which the recording position of the photography still image and voice code image provided in an external apparatus such as photography device is designated on the printing medium; or determining the layout of the photography still image based on the instruction supplied from the printer in order to set the recording position of the photography still image on the printing medium.

(26) The printer according to (23), further comprising a voice recording position setting section for setting a recording position of the voice code image recorded on the printing medium, wherein

the notifying section supply a predetermined warning when the determination section determines that the recording position information is associated with the image data, and when the voice recording position setting section sets a recording position of the voice code image.

That is, although recording position information is associated with image data, when the printer supplies an instruction for such association in order to set the recording position of the voice code image, the user can be warned of the fact. Thus, the user can take appropriate action for a method for setting the recording position of these photography still image and voice code image on the printing medium.

(27) The printer according to (26), further comprising a selection section for selecting any one of settings provided by the voice recording position setting section and provided based on the recording position information when the recording position of the voice code image is set.

That is, the user can select arbitrarily either of the methods for determining the layout of these photography still image and voice code image based on the recording position information on which the recording position of the photography still image and voice code image provided in an external apparatus such as photography device is designated on the printing medium; or determining the layout of the voice code image based on the instruction supplied from the printer in order to set the recording position of the voice code image on the printing medium.

(28) The printer according to (15), further comprising an image display section for visualizing and displaying the photography still image based on the image data input by the input section.

That is, the user can visually check easily a photography still image based on the input image data, and thus, making it possible to judge in advance a selection of whether or not the photography still image is recorded on the printing medium.

(29) The printer according to (15), further comprising a voice input section for inputting a voice recorded as the voice code image on the printing medium.

That is, the user can newly input a voice on the printer and create a voice code image even if voice data is not associated with the input image data. Thus, even if only a photography still image is provided, the user can record the photography still image and voice code image on the same printing medium.

(30) The printer according to (29), further comprising a voice edit section for editing a voice input by the voice input section.

That is, the user can desirably edit (change) a voice input by the printer, thus making it possible to obtained a more sophisticated printing medium with a voice code image.

(31) The printer according to (29), further comprising a voice recording position setting section for setting a recording position of the voice code image recorded on the printing medium.

That is, the user can set (change) the recording position of the voice code image on the printing medium based on the voice input on the printer to a desired recording position, thus making it possible to obtain a more sophisticated printing medium with a voice code image.

(32) The printer according to (29), further comprising a voice output section for outputting at least one of a voice input by the voice input section and a voice based on voice data associated with the image data.

That is, the user can check directly the content of the voice input by the printer or the content of the voice based on the voice data associated with the input image data by means of a speaker. Thus, the user can judge in advance a selection of whether or not to record such voice as a voice code image on the printing medium.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A photography device for use in a photography image processing system capable of recording an optically readable voice code image on a printing medium having a photography still image recorded thereon, comprising:
a voice input section for inputting a voice corresponding to the voice code image;
a digital conversion section for converting an input voice in said voice input section to digital voice data;
a voice data memory for storing the converted digital voice data by said digital conversion section; and
a relating data generating section for generating relating data for associating a photography still image and a voice code image recorded on the same printing medium,
wherein said voice data memory inputs the relating data generated by said relating data generating section, associates the input relating data with the associated voice data, and stores the relating data.

2. The photography device according to claim 1, further comprising a voice compression section for compressing the converted digital voice data by said digital conversion section,
wherein said voice data memory stores the compressed voice data by said voice compression section.

3. The photography device according to claim 2, wherein
said photography device is a film camera for use in a photography image processing system capable of recording a photography still image exposed on a film by baking the image to a printing paper that is the printing medium and recording the voice code image on the same printing paper, and
said film camera further comprises a data output terminal for externally outputting voice data and relating data associated with the voice data stored in said voice data memory.

4. The photography device according to claim 3, wherein said film camera is constructed so that at least one of the relating data generated by said relating data generating section and information associated therewith is displayed to be recorded at a predetermined portion on the film.

5. The photography device according to claim 2, wherein
said photography device is a film camera for use in a photography image processing system capable of recording a photography still image exposed on a film by baking the image to a printing paper that is the printing medium, and recording the voice code image on the same printing paper, and
said film camera have said voice data memory detachably arranged thereon.

6. The photography device according to claim 5, wherein said film camera is constructed so that at least one of the relating data generated by said relating data generating section and information associated therewith is displayed to be recorded at a predetermined portion on the film.

7. The photography device according to claim 2, wherein
said photography device is an electronic still camera for use in a photography image processing system comprising an image memory for outputting a photography still image exposed on a light receiving surface of an image pick-up device as an image signal, and storing image data having the output image signal digitized, the system being capable of recording an image based on the image data stored in said image memory on the printing medium, and recording the voice code image on the same printing medium,
said electronic still camera has said image memory compatible with said voice data memory, and
said image memory stores the image data, voice data, and relating data to be associated with.

8. The photography device according to claim 7, wherein said electronic still camera further comprises a data output terminal for externally outputting the image data, voice data, and relating data stored in said image memory.

9. The photography device according to claim 7, wherein said electronic still camera has said image memory detachably arranged thereon.

10. The photography device according to claim 2, wherein said relating data generating section is constructed so as to be automatically generate the relating data based on predetermined operation before or after photography.

11. The photography device according to claim 10, wherein the relating data includes a photography frame number of a photographed still image.

12. The photography device according to claim 2, wherein said relating data generating section is constructed so as to generate the relating data based on manual input operation before or after photography.

13. The photography device according to claim 2, wherein
said photography device further comprises a recording position setting section for setting a recording position of the voice code image on the printing medium, and
said voice data memory is constructed so as to store information concerning the recording position of the voice code image set by said recording position setting section to be associated with the voice data and the relating data.

14. The photography device according to claim 13, wherein said photography device further comprises a display section for displaying a recording position of the voice code image set by said recording position setting section.

15. The photography device according to claim 14, wherein said display section is provided in a photography finder.

16. The photography device according to claim 1, wherein
said photography device is a film camera for use in a photography image processing system capable of recording a photography still image exposed on a film by baking the image to a printing paper that is the printing medium and recording the voice code image on the same printing paper, and
said film camera further comprises a data output terminal for externally outputting voice data and relating data associated with the voice data stored in said voice data memory.

17. The photography device according to claim 16, wherein said film camera is constructed so that at least one of the relating data generated by said relating data generating section and information associated therewith is displayed to be recorded at a predetermined portion on the film.

18. The photography device according to claim 1, wherein
said photography device is a film camera for use in a photography image processing system capable of recording a photography still image exposed on a film by baking the image to a printing paper that is the printing medium, and recording the voice code image on the same printing paper, and
said film camera have said voice data memory detachably arranged thereon.

19. The photography device according to claim 18, wherein said film camera is constructed so that at least one of the relating data generated by said relating data generating section and information associated therewith is displayed to be recorded at a predetermined portion on the film.

20. The photography device according to claim 1, wherein
said photography device is an electronic still camera for use in a photography image processing system comprising an image memory for outputting a photography still image exposed on a light receiving surface of an image pick-up device as an image signal, and storing image data having the output image signal digitized, the system being capable of recording an image based on the image data stored in said image memory on the printing medium, and recording the voice code image on the same printing medium,
said electronic still camera has said image memory compatible with said voice data memory, and
said image memory stores the image data, voice data, and relating data to be associated with.

21. The photography device according to claim 20, wherein said electronic still camera further comprises a data output terminal for externally outputting the image data, voice data, and relating data stored in said image memory.

22. The photography device according to claim 20, wherein said electronic still camera has said image memory detachably arranged thereon.

23. The photography device according to claim 1, wherein said relating data generating section is constructed so as to be automatically generate the relating data based on predetermined operation before or after photography.

24. The photography device according to claim 23, wherein the relating data includes a photography frame number of a photographed still image.

25. The photography device according to claim 1, wherein said relating data generating section is constructed so as to generate the relating data based on manual input operation before or after photography.

26. The photography device according to claim 1, wherein
said photography device further comprises a recording position setting section for setting a recording position of the voice code image on the printing medium, and
said voice data memory is constructed so as to store information concerning the recording position of the voice code image set by said recording position setting section to be associated with the voice data and the relating data.

27. The photography device according to claim 26, wherein said photography device further comprises a display section for displaying a recording position of the voice code image set by said recording position setting section.

28. The photography device according to claim 27, wherein said display section is provided in a photography finder.

29. A printer for use in a photography image processing system capable of recording an optically readable voice code image on a printing medium having a photography still image recorded thereon, comprising:
an input section for inputting image data corresponding to the photography still image;
a determination section for judging whether or not voice data to be recorded as the voice code image on the same printing medium together with the photography still image based on the image data is associated with image data input by said input section;
an instructing section for instruction a selection of whether or not the voice code image is recorded on the printing medium; and
a control section for, when said determination section determines that the voice data is associated with the image data, and when said instructing section instructs a selection for recording the voice code image on the printing medium, recording the photography still image and the voice code image on the same printing medium.

30. The printer according to claim 29, further comprising a photography still image selection section for selecting the photography still image recorded on the printing medium.

31. The printer according to claim 29, further comprising a notifying section for, when said determination section determines that the voice data is associated with the image data, notifying the determination result.

32. The printer according to claim 29, further comprising a warning section for, when said determination section determines that the voice data is not associated with the image data, and when the instruction is given to a selection for recording the voice code image on the printing medium, supplying a predetermined warning.

33. The printer according to claim 29, further comprising an image edit section for editing the photography still image corresponding to the image data input by said input section.

34. The printer according to claim 29, further comprising an image recording position setting section for setting a recording position of the photography still image to be recorded on the printing medium.

35. The printer according to claim 29, further comprising a voice edit section for editing the voice associated with the image data.

36. The printer according to claim 29, further comprising a voice recording position setting section for setting a recording position of the voice code image recorded on the printing medium.

37. The printer according to claim 29, wherein
said determination section include an association determination section for judging whether or not recording position information is associated with the image data input by said input section other than the voice data, the recording position information defining a recording position of the voice code image on a same printing medium, and
said printer further comprises a notifying section for, when said association determination section determines that the recording position information is associated, notifying the determination result.

38. The printer according to claim 37, further comprising an image recording position setting section for setting a recording position of the photography still image recorded on the printing medium, wherein
said notifying section supply a predetermined warning when said determination section determines that the recording position information is associated with the image data, and when said image recording position setting section sets a recording position of the photography still image.

39. The printer according to claim 38, further comprising a selection section for selecting any one of settings provided by said image recording position setting section and provided based on the recording position information when the recording position of the photography still image is set.

40. The printer according to claim 37, further comprising a voice recording position setting section for setting a recording position of the voice code image recorded on the printing medium, wherein
said notifying section supply a predetermined warning when said determination section determines that the recording position information is associated with the image data, and when said voice recording position setting section sets a recording position of the voice code image.

41. The printer according to claim 40, further comprising a selection section for selecting any one of settings provided by said voice recording position setting section and provided based on the recording position information when the recording position of the voice code image is set.

42. The printer according to claim 29, further comprising an image display section for visualizing and displaying the photography still image based on the image data input by said input section.

43. The printer according to claim 29, further comprising a voice input section for inputting a voice recorded as the voice code image on the printing medium.

44. The printer according to claim 43, further comprising a voice edit section for editing a voice input by said voice input section.

45. The printer according to claim 43, further comprising a voice recording position setting section for setting a recording position of the voice code image recorded on the printing medium.

46. The printer according to claim 43, further comprising a voice output section for outputting at least one of a voice input by said voice input section and a voice based on voice data associated with the image data.
